(19) United States
(12) Patent Application Publication
(10) Pub. No.: US 2016/0180030 A1
(43) Pub. Date: Jun. 23, 2016

(54) System and Method for Analyzing Revenue Cycle Management

(71) Applicant: Synergen Health, LLC, Dallas, TX (US)

(72) Inventors: Mel Gunawardena, Dallas, TX (US); Duminda Gunawardena, Dallas, TX (US); Pilippumandudige Nimshan Lionel Fernando, Nugegoda (LK); Angela Thayalini Thayalaseelan, Nugegoda (LK)

(73) Assignee: Synergen Health, LLC, Dallas, TX (US)

(21) Appl. No.: 14/909,315

(22) PCT Filed: Feb. 12, 2015
(86) PCT No.: PCT/US2015/015707

§ 371 Date: Feb. 1, 2016

Related U.S. Application Data
(60) Provisional application No. 61/940,220, filed on Feb. 14, 2014.

(51) Int. Cl. G06F 19/00

(52) U.S. Cl. CPC G06F 19/327; G06F 19/328

(57) ABSTRACT

The principles of the present invention provide for optimizing healthcare/dental-care revenue cycle management through dynamic information analysis. The principles of the present invention incorporate interactive, exploratory data analyses of the full revenue cycle management processes and interrelated systems. Such analyses may include functions of appointments, scheduling, billing, posting, denial management, collections, whilst integrating hospital, physician, practice management, sales, marketing, finance and other interrelated systems and/or functions. As a result, complete, consistent, derivative, quality data analysis allowing users to identify initial and sub-process performances and their effects on the main business process enriching decision-making capabilities for medical service providers.

### RELATED APPLICATION DATA

This application is related to Provisional Patent Application Ser. No. 61/940,220 filed Feb. 14, 2014, and priority is claimed for this earlier filing under 35 U.S.C. §119(e). Provisional Patent Application is also incorporated by reference into this patent application.

### TECHNICAL FIELD

The present invention relates to a method and system for capture and analysis of healthcare data and information.

### BACKGROUND OF THE INVENTION

Healthcare and dental care management has been through a variety of reforms. Over the years with the growth of information technology, there have been introductions of practice management and other interrelated software systems to help manage different aspects of the healthcare business. These basic systems operate more as front-end clinical and practice information capture systems, and were not built to support advanced report customization or development requirements. Consequently, these systems fall short of data analysis and healthcare management.

With recent legal health reforms, various information technology issues, such as privacy, security of patient information, health insurance, and health information technology, were introduced to the healthcare industry. The conventional practice management and interrelated systems went through considerable transformations and upgrades to cater to the frequencies of updates required. Nevertheless, the upgrades fell short of sophisticated agile analytics and management reporting tools whilst ensuring legal compliance.

Over time, various basic interrelated systems were introduced throughout the healthcare provider value chain to cater to an array of needs with hospital, clinical, physician based, scheduling, insurance, coding, sales and marketing, legal and finance functions. These interrelated systems were adopted at the requirements and convenience of the providers. A mass of systems helped streamline a variety of specialized functions. However, these systems fell short on inter-functional data analysis and management.

Next, analytic software tools were introduced to the market at minimum levels of success. The systems did not incorporate interactive, exploratory data analysis of the full revenue cycle management workflow process, nor did they integrate the interrelated systems introduced to manage the facilities. The need for holistic data analysis of the revenue cycle management function remained unfulfilled as customization remained a challenge to many.

Another deficiency that is prevalent in these upcoming analytic software tools is that the tools are limited in the type of data that can be captured and presented to the user, as the system architecture is limited to high-level data.

User friendly, interactive, interchangeable graphical representations with valid alerts is another drawback in many of the analytic software tools. Users are incapable of maximizing time and resources in the management of the healthcare facilities

Across specialties and regions the practice performance analysis varied immensely. Most of the analytic platforms are not able to cater to identify and incorporate diverse customizable key performance indicators. The systems are also incapable of diagnostic, predictive, and prescriptive self-exploratory data analysis that allows user easy decision making and forecasting capabilities.

Another drawback in these systems are that they do not cater to quality reporting, such as meaningful use, physician quality reporting system (PQRS), outcome reporting and/or population health management.

### SUMMARY OF THE INVENTION

The principles of the present invention provide for optimizing healthcare/dental-care revenue cycle management through dynamic information analysis. The principles of the present invention incorporate interactive, exploratory data analysis of the full revenue cycle management processes and interrelated systems. Such analysis may include functions of appointments, scheduling, billing, posting, denial management, collections, whilst integrating hospital, physician, practice management, sales, marketing, finance and other interrelated systems and/or functions. As a result, complete, consistent, derivative, quality data analysis allows users to identify initial and sub-process performances and their effects on the main business process enriching decision-making capabilities for medical service providers. Configured to operate on multiple viewing platforms, the principles of the present invention provide access via cloud computing and mobile devices, providing healthcare business professionals access to practice information anywhere and any time. Protected health information is not captured at any point in the system, and therefore does not encumber patient privacy or safety by means of unauthorized access or theft. The principles of the present invention system overcome the issue of integrating with the various custom-built practice management systems that were historically introduced to the healthcare industry. Being platform agnostic enables the system to integrate with a variety of systems utilizing Structured Query Language or other databases. The system and processes therefore provide for a tool enabling easy access and more holistic data analysis, translating to efficient and effective healthcare revenue cycle management.

The principles of the present invention utilize logical schemas, algorithms and other architectural designs, and allow for high-performance data analysis with granular level drill down capabilities. The platform agnostic system allows for narrowing-down the user selected data analysis point to such a granular level it populates the transaction entry details. The logical narrow-down capabilities are widespread per the system architecture adopted allowing user to analyze the same data point based on a variety of custom fields. By drilling down to the transaction or claims-level, medical service professionals are able to capture practice or physician strengths, issues and potentials based on actual practice performance data. Moreover, deviations from trends are easily identified and issue rectification process may be instantaneous. This, in turn, helps with the longer-term management of the healthcare practice.

A revenue cycle management process may include a variety of users with varying levels of skills and expertise. The principles of the present invention address the issue of adaptability, being a data discovery tool allowing for interactive, interchangeable data analysis with easy to use, easy to understand tools, requiring minimum training and knowledge transfer. By offering interactive, interchangeable visualization features through mediums of graphs, dashboards, maps, trends and charts the present invention shifts business intelligence from a descriptive to a diagnostic data quantification process. The principles of the present invention may include complete visualization features that highlight and alert diagnosed data patterns. With a click of a button, a user is able to interchange between preferred visualization mediums, thereby helping user to gear towards high-performance, exploratory data analysis.

One embodiment of a method of performing medical services analytics may include collecting raw medical services data from at least one data repository. The raw medical services data may define a first set of medical services data received from a practice management system operated by a medical service provider. The first set of medical services data may be mapped to generate a second set of medical services data. Multiple new medical services data elements may be calculated by using at least one pre-established transformation formula configured to process the second set of medical services data. The multiple new medical services data elements may be integrated into the second set of medical services data to generate an integrated medical services data set. A dashboard may be driven with the integrated medical services data set for the medical services provider to view.

One method of a method of presenting a dashboard for medical services analytics may include accessing a medical services data set inclusive of data related to medical services performed by a medical services provider. The dashboard inclusive of a table may be generated, where the dashboard may include multiple workflow selectable elements. The workflow selectable elements may include time period, provider, insurance carrier, and medical procedure code. In response to a selection of a selectable element, the table may be caused to display different respective data subsets in the table associated with the selected element.

### BRIEF DESCRIPTION OF THE DRAWINGS

Illustrative embodiments of the present invention are described in detail below with reference to the attached drawing figures, which are incorporated by reference herein and wherein:

FIG. 1 is illustrative of the environment in which a medical service provider operates;

FIG. 2 is illustrative of the environment in which a hospital/clinic network operates to provide medical services to patients;

FIG. 3A is illustrative of the system configured to provide healthcare analytics via a dashboard user interface for a medical service provider;

FIG. 3B is a detailed block diagram illustrative of FIG. 3A configured to provide healthcare analytics via a dashboard user interface for a medical service provider;

FIG. 4 is a workflow diagram illustrative of operations and data generation of a practice of a medical service provider and dashboard user interface data for the medical service provider to view on a dashboard user interface;

FIG. 5 is a detailed block diagram illustrative system of healthcare analytics inclusive of customer relationship management data for presentation on a dashboard user interface;

FIG. 6 is a detailed block diagram illustrative of healthcare analytics inclusive of accounting data of the medical service provider for presentation on a dashboard user interface; and

FIG. 7 is illustrative of the interactive graphical user interface or dashboard;

FIGS. 8A and 8B are illustrative of the appointment analysis interactive user interface to enable a user to analyze and manage appointment operations of a medical service provider;

FIG. 9 is illustrative of the claims submission interactive user interface;

FIGS. 10A-10D are illustrative of the production dashboard showing overall production of a medical services provider;

FIG. 11 is an illustrative of the dashboard 1100 that presents work relative value units (RVUs) for providers (e.g., physicians);

FIGS. 12A-12C are illustrative of the deposits dashboard to assist a medical service provider to manage and analyze deposits by the practice;

FIGS. 13A-13D are of the illustrative of the aging revenue dashboards that enable a medical service provider to monitor aging revenue of a medical practice;

FIGS. 14A-14C are illustrative of the reimbursement summary dashboard that tracks reimbursements for a medical service provider; and

FIG. 15 illustrative of the details dashboard that provides claim-level details for a medical service provider;

FIGS. 16A-16D are illustrative of the CPT & payer mix dashboards that enable a medical service provider to access and view payments on a CPT and payer basis;

FIG. 17 is an illustrative of the rollover analysis dashboards that enable a user to dynamically select a number of days after which uncollected claims will rollover into a 90+ day AR bucket and to view summary and/or claim-level data;

FIG. 18 is an illustration of an illustrative claims rollover analysis process; and

FIG. 19 is an illustration of the interaction between tabs and dashboard.

### DETAILED DESCRIPTION

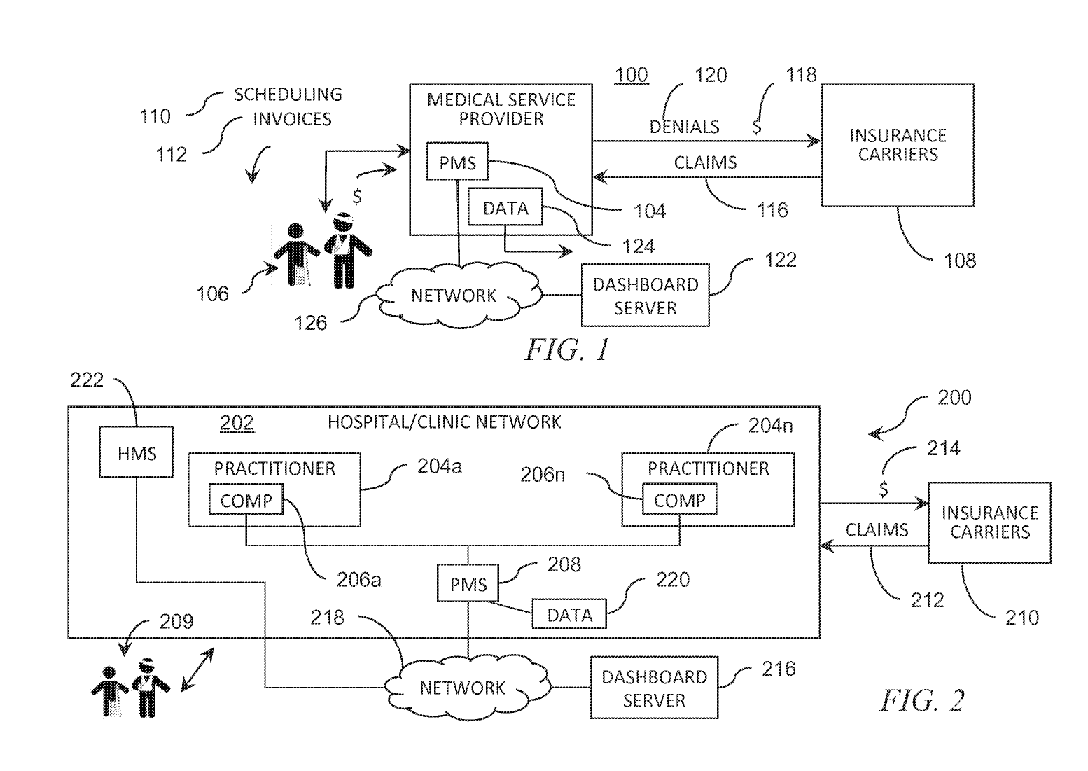

With regard to FIG. 1, the environment 100 in which a medical service provider 102 utilizes a practice management system (PMS) 104 in providing medical care is shown. The medical service provider 102 may be a solo medical service practitioner, such as a doctor, dentist, or any other medical professional, as understood in the art. The medical service provider 102 utilizes the practice management system 104 to manage workflow of the medical practice in terms of scheduling patients 106, interacting with insurance carriers 108, managing collections, cash flow, and other operations of a medical practice. As is understood in the art, there are a number of PMS systems available for medical service providers to use, and each one of these PMS systems provide relatively common functionality. However, as also understood in the art, these PMS systems have limited analytics capabilities as a result of reporting being generally preset and static in nature, and, therefore, provide limited reporting outputs for the medical service provider to manage the medical practice. For the most part, these practice management systems are antiquated with regard to providing sufficient reporting of information that is managed by the practice management systems. While certain information may be available, it is very time consuming and challenging to answer a variety of questions from available reports from existing PMS systems. As a result of the PMS systems not providing static and insufficient information in existing reports, consultants are often used to assist medical service providers to help improve financial efficiency for the medical service providers.

The medical service provider 102 who provides medical services to patients 106 uses the PMS 104 for scheduling the patients 110, invoicing the patients 112, managing payments 114 from the patients, and performing other interactions with the patients. As well understood in the art, the medical service provider 102 interacts with insurance companies 108 with which the patients 106 have insurance. As also understood in the art, the insurance carriers 108 may be private health insurance carriers and governmental health insurance carriers, such as Medicaid and Medicare. Whether private or public, the medical service provider 102 sends claims 116 to the insurance carriers 108 who, in response to processing the insurance claims 116, pay the medical service provider 102 with money 118 to satisfy the claims 116 of the medical service provider 102 for patients 106. Despite contracts and approved procedure payment amounts being established each year between the medical service provider 102 and insurance carriers 108, there are many reasons why insurance carriers 108 delay payments to the medical service provider 102 for the claims 110. In some cases, the claims are miscoded, in other cases the claims are missing sufficient information for the insurance carriers 108 to pay, and in other cases, insurance carriers 108 are simply slow in paying. Many other reasons for slow payment from insurance carriers exists.

Whether the insurance carriers 108 are timely in paying for medical procedures that have been submitted via the insurance claims 116 or untimely for whatever reason, the medical service provider 102 using the PMS 104 has to manage cash flow in order to stay in business. In order to stay in business, a business manager, be it a doctor or practice manager, has to be provided with sufficient information that can help in determining status of payments and reason why payments for the medical services is slow to be paid or not paid at all so that adjustments to the business can be made to improve the financial health of the business of the medical service provider 102.

In accordance with the principles of the present invention, a dashboard server 122 located on a network 126, such as the Internet, may be configured to receive data 124 from the practice management system 104. The data 124 received from the practice management system 104 may include raw data, such as claim-level data, and post-processed data that may include new data that is derived from the raw data collected by the practice management system 104. The data 124 may be used by the dashboard server 122 to provide information to a user of a dashboard (i.e., user interface) that assists the user in monitoring and “diagnosing” cash flow and other financial and nonfinancial issues that are occurring with the medical service provider 102. The dashboard server 122 is practice management system agnostic in that it is capable of collecting data and delivering dashboards as further provided herein by collecting data from any practice management system. As understood in the art, each PMS has a different data structure, and collecting data from the different data structures is not trivial.

With regard to FIG. 2, the hospital/clinic network environment 200 is shown. The environment 200 may include a hospital or clinic network 202 in which multiple medical service practitioners 204a-204n (collectively 204) conduct medical practices. Each of the practitioners 204 may operate a computing system 206a-206n (collectively 206) that may be in communication with practice management system 208 operated by the hospital/clinic network 202. It should be understood that the computing systems 206 may be any desktop and/or mobile device capable of access the PMS 208 via a local area network, wide area network (e.g., Internet), private network or other communications network to enable the practitioners 204 to access the PMS 208 for day-to-day operations, thereby enabling the hospital/clinic network 202 to manage the overall operations of the hospital/clinic network 202. This hospital/clinic may also have a separate hospital management system 222 that would help manage the facility related services rendered, claims billed out, revenue codes, related transactions and other hospital demographic information. More often than not this would be the key system the preferred embodiment would connect to in order to deep dive and display the hospital related key performance indicators. The hospital setting would generally use UB 04 claim forms for submission tracking items such as inpatient outpatient services, case type information, DRG. These information elements would be pulled into the dashboards and displayed to the user as required.

Despite the hospital/clinic network 202 having economies of scale by having multiple practitioners 204 operating a medical practice, the basic fundamentals of operating a business in the medical industries with patients 209 and insurance carriers 210 are similar to those provided in FIG. 1. Whether the PMS 208 is configured to manage multiple practitioners 204 or a single medical service provider 102 (FIG. 1), the information that is helpful to a medical practice is generally the same. In accordance with the principles of the present invention, a dashboard server 216 may be configured to receive, via a communications network 218, data 220 from the PMS 208 to process and display on a dashboard (i.e., interactive user interface) for a user charged with managing financial operations of the hospital/clinic network 202.

Despite the simplicity shown in FIGS. 1 and 2, it should be understood that the PMS systems 104 and 208 are quite extensive and elaborate, and simply extracting data from these systems is not trivial as a result of these systems having extensive data structures that operate within databases to manage data of the medical practices. Moreover, in order to provide a medical service provider and hospitals/clinics with information that is helpful in managing their practices, a significant amount of expertise in collecting, processing, and presenting useful data that is currently unavailable in these practice management systems dictates what specific information is to be collected from the practice management systems, how to process the information collected from the practice management systems, and how to display the information in a helpful, intuitive, and fast manner for users of the dashboard is also not a trivial exercise. It should be understood that practice management systems are sometimes known as healthcare management systems or healthcare information systems.

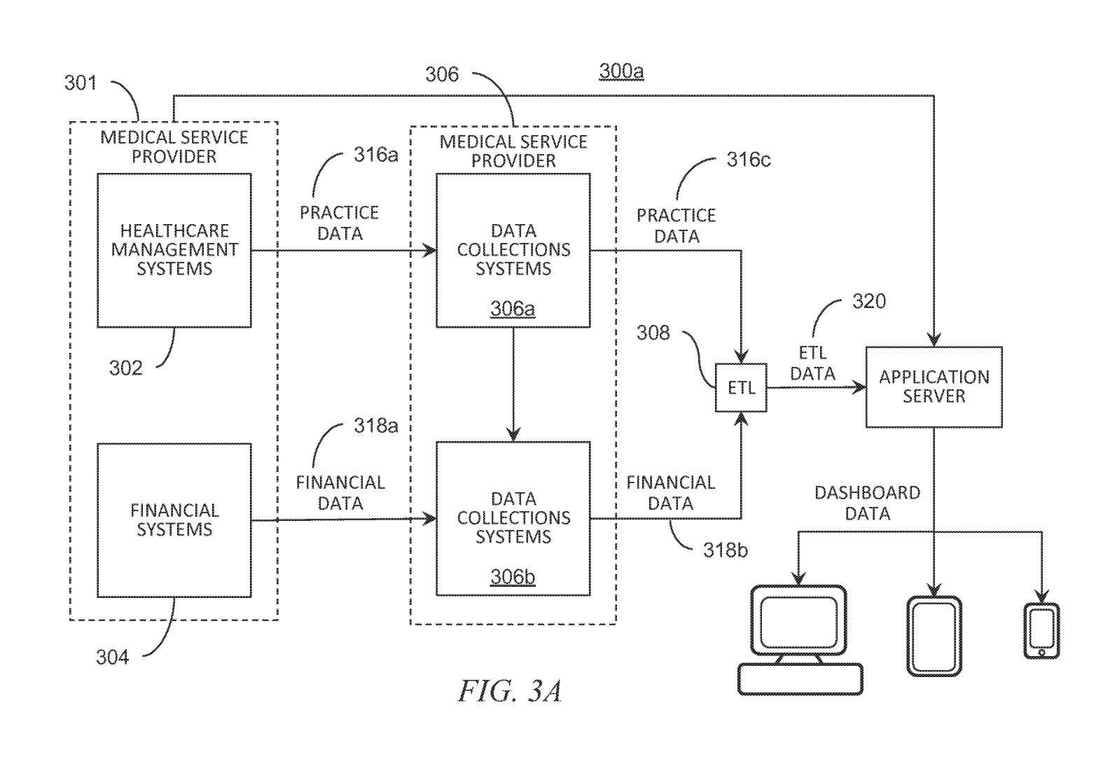

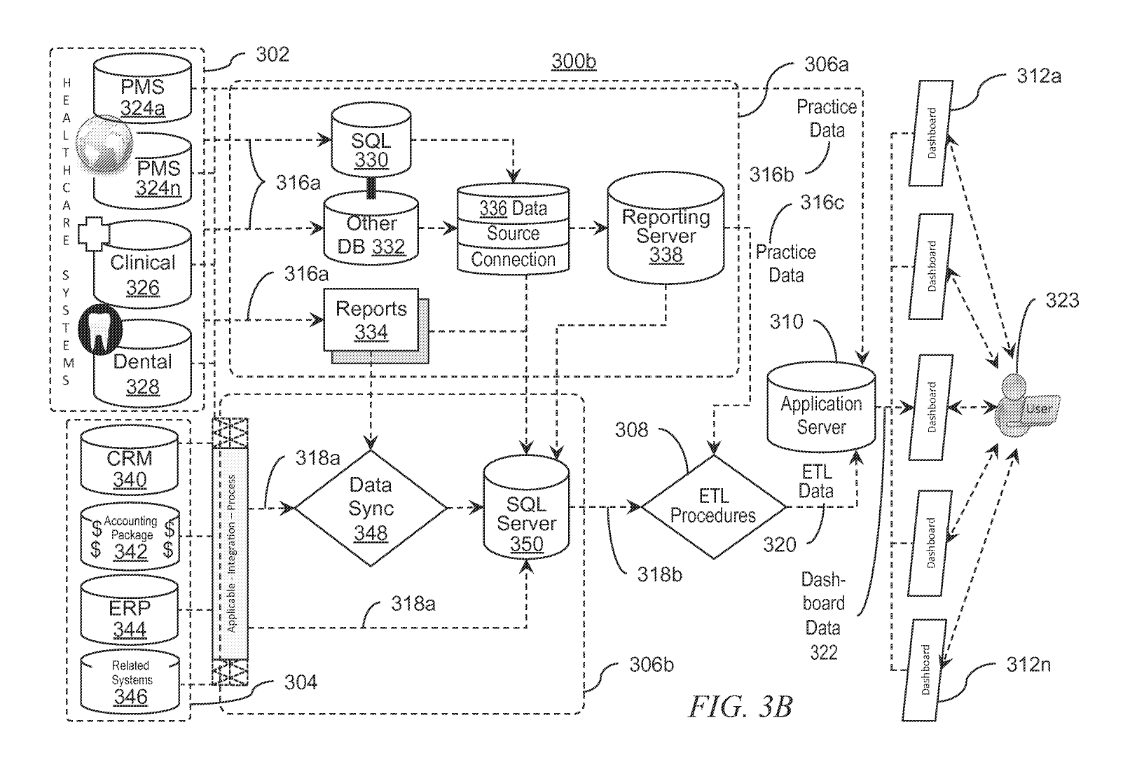

With regard to FIG. 3A, a block diagram of system 300a configured to provide healthcare analytics for a medical service provider is shown. The system 300a may allow a medical service provider 301 who operates one or more healthcare management systems 302 to manage a medical practice. The medical service provider 301 may be a solo practitioner or a hospital/clinic network in which multiple medical service providers practice. The medical service provider 301 may also operate one or more financial systems 304 configured to enable the medical service provider to manage financial operations (e.g., revenues and/or expenses) of the medical service provider 301. In one embodiment, the financial systems 304 may be QuickBooks® or any other financial system, as understood in the art. The healthcare management systems 302 and financial systems 304 may be separate or integrated, as understood in the art.

The system 300a may further include data collection systems 306a-306b (collectively 306), extract, transform, and load (ETL) procedures 308, and application server 310 configured to execute dashboard processes of which the medical service provider 301 may interact via electronic devices 312a-312n (collectively 312). The data collection systems 306a and 306b may be integrated or be separated into two or more systems. As shown, electronic devices 312 may include desktop computers 312a, mobile tablets 312b, smartphones 312c, and/or any other electronic device that may be used to access and display a dashboard provided by the application server 310 and accessible via a communications network 314, such as the Internet and/or mobile communications network, as understood in the art. In one embodiment, the ETL procedures 308 operate on a separate computing device. Alternatively, the ETL procedures 308 may be software processes operating on the application server 310 and/or data collection systems 306.

In operation, and medical service provider may utilize the healthcare management systems 302 to generate practice data 316a and 316b. The practice data 316a may include all or a portion of data generated by the healthcare management system 302. In one embodiment, the practice data 316a and/or 316b may not include patient identifier information generally known as protected healthcare information (PHI) so as to comply with HIPAA laws. In that regard, the application server 310 along with any software modules (not shown) that may be integrated with any of the healthcare management systems 302, financial systems 304, data collection systems 306, and/or ETL procedures 308, may be configured to exclude any PHI data. The practice data 316a and 316b may be the same or different depending upon operation of the application server 310 and data collection systems 306a.

Furthermore, the data collection system 306a may collect the practice data 316a to generate reports for the medical service provider. The medical service provider may further use the financial systems 304 to generate financial data 318a that is communicated to the data collection systems 306b, and the data collection systems 206b may be configured to receive and process the financial data 318a to generate reports for the medical service provider. As previously described, the data collection systems 306a and 306b typically collect data from a variety of sources to manage a medical practice for a variety of reasons. As such, the ETL procedures 308 may be configured to access and/or receive practice data 316c and financial data 318b for processing to generate data to display on dashboard screens. The practice data 316c may be the same or modified from the practice data 316a, as the practice data 316c may be modified from the practice data 316a by the data collection systems 306a. Similarly, the financial data 318b may be modified from the financial data 316b by the data collection systems 306b.

The application server 310 may be configured to access and/or receive the practice data 316b and ETL data 320. In response, the application server 310 may be configured to process the practice data 316b and ETL data 320 to generate dashboard data 322 for use in the dashboard screens (not shown) that may include raw or detailed data, such as medical claims data without specific patient data, and pre-processed data as generated by the ETL procedures 308 performing computations on the practice data 316c and/or financial data 318b that may be in the ETL data 320. The application server 310 may process the data 316b and 320 by organizing and/or generating additional data in a manner that allows a user of the electronic devices 312 to view on various dashboard screens, as further provided herein.

As previously described, practice management systems typically provide a medical service provider with the ability to generate reports. However, such reports are static in nature and offer limited visibility into a medical practice. Other conventional analytic systems are able to access practice management data, but have limited capability and, too, are generally static in nature in that user interactivity is limited. The principles of the present invention provide for the application server 310 to load the ETL data 320 in memory using a software platform, such as QlikView, Tableau, or other software platform.

With regard to FIG. 3B, a more detailed block diagram of system 300b of FIG. 3A configured to provide healthcare analytics via a dashboard user interface for a medical service provider is shown. The system 300b is shown to include the healthcare management systems 302, financial systems 304, data collection systems 306a, data collection systems 306b, ETL procedures 308, application service 310, and electronic devices 312 configured to display a dashboard user interface to a user 323.

The healthcare management systems 302 may include (i) practice management systems (PMSs) 324a-324n (collectively 324) configured for solo practitioners or enterprise operations to support multiple medical practitioners in a hospital or clinic with multiple medical professionals, (ii) clinical practice management system 326, (iii) dental practice management system 328, or (iv) other systems used by medical service providers in managing their medical practice. Practice data 316a collected and/or generated by the healthcare management systems 302 may be accessed and/or received from the healthcare management systems 302 by the data collection systems 306a. As shown, the practice data 316a or portions thereof may be collected and stored by an SQL data repository 330, other database 332, or reports system 334 (e.g., spreadsheets). A data source connection 336 may be in communication with the SQL database 330 and/or other database 332 for storage and communication of some or all of the practice data 316a that is collected from the healthcare management systems 302.

The reporting server 338 may be configured to receive and process data from the SQL database 330, other databases 332, and data source connection 336. The reporting server 338 may be a server or other computing system that operates in conjunction with other data collection systems 306a that may be configured to collect data for use with the ETL procedure 308. Practice data 316c from the reporting server 338 may be output or accessed by the ETL procedures 308 and processing thereby.

The financial systems 304 may include a customer relationship management (CRM) system 340, accounting package 342, enterprise resource planning (ERP) system 344, and related systems 346. In one embodiment, an applicable integration process 348 may be utilized to integrate each of the systems 340, 342, 344, and 346 with the data collection systems 306b. The applicable integration process 348 may generate financial data 318a. A data synchronization process 348 may synchronize the financial data 318a with practice data 316a as produced by the reports system 334. The SQL server 350 may receive synchronized data from the data sync process 348 as well as financial data 318a for storage therein. The ETL procedures 308 may receive the practice data 316c and financial data 318b for processing thereat to prepare ETL data 324. The application server 310, as previously described, may generate and/or communicate dashboard data 322 to the electronic devices 312 for the user 323 to view.

FIG. 3B displays a mechanism of collecting raw medical services that would include the most detailed transaction level of the medical insurance claim and similar related data using direct connections to SQL databases, connections to other databases, upfront reports, data source connections, reporting servers, data sync processes (330, 332, 334, 336, 338 & 348) which is mapped to a central cloud based SQL server 350. The mapped data would then be integrated, extracted, transformed and loaded to the application server on a real time basis using calculations based on a variety of transformational formulae and programming languages which would then be driven to an application dashboard or user interfaces 312a-312n.

Healthcare Management Systems subroutine 302 is the practice management system (PMS) 324a, the web based PMS 324n, clinical systems 326 and dental systems 328. PMS 324a and web based PMS 324n are systems that are generally owned and operated on by the provider, physician or healthcare facility in the day to day administration of the practices. These systems cumulatively help administer the revenue cycle management, clinical and dental practice management processes in the healthcare industry.

The PMS 324a is a system that captures all input from a patient that makes a call to the practice requesting an appointment, to the patient's demographic information, and patient's insurance plan related information. This data and information is input to record the patients visit to the facility, the diagnosis made (ICD 9 or 10 codes), to what services were performed to the patient (CPT/HCPC codes), to who performed the service to when and why it was performed, how long the whole process lasted. Then the practice manager and their team or a third party hired for the same purpose is given the task of billing out the claim relating to the same service.

The charge per service would be captured in separate line item levels, and would be payments are tracked as received pertaining to the billed out claim or subsequently the denials for pay sent back by the insurance carriers in the form of explanation of benefits (EOB) or electronic remittance advices (ERA). These payments would be posted to the system 302. That would lead to the tracking of the claims that have aged over a time period without proper payments being received.

The follow up process on each claim would be tracked using functions available in the various PMS 324a. It should be understood that not all of the PMS 324a would go to the same level of detail described above. Even though the above described raw medical services data is captured in most PMS 324a, it is not easily retrievable, or connectable to or exportable or extractable at any given time. The database they reside on, the ease of extraction, the ease of connectivity to the database would be a few of the variables that would affect the success of this extraction or export process or the retrieval of this information or the ability to connect directly to this data.

The reporting functionality in most of the PMS 324a would be able to pull information into a set of self-exploratory and interactive dashboards in the current invention.

A web based PMS 324b operates in a similar manner as described for PMS 324a. The key differentiator between PMS 324a and PMS 324b is that PMS 324b would be hosted on a wide area network using a secure URL. Hence PMS 324b would generally be accessible easily over the internet and in most locations using various devices such as computers, laptops, mobile devices, tabs, PDAs.

The clinical system 326 captures information related to quality of patient care, medical findings and diagnoses. Clinical system 326 captures electronic medical records and electronic health records The invention is sophisticated enough to collect required information directly from the clinical system 326, and/or, from a clinical system 326 that integrates one to one with the PMS and thereby the information captured in the clinical system does not need to be re-input into the PMS 324a and PMS 324b The information captured in these systems is more in line with improving the quality of patient care and is streamlined to cater to the requirements of Physician Quality Reporting System (PQRS). As physicians are provided incentives for adopting the same, it has become an increasingly needed area of reporting and analysis. The reporting capabilities provided in progress reporting, drug assignment, discontinuation/early termination, are some of the data elements that the system tracks in terms of quality patient care.

The dental healthcare revenue cycle management 328 integrates critical data elements to the revenue cycle manager that are input into the system such as appointment scheduling, determining insurance eligibility and plan benefits, claims submissions, insurance payments, and patient billing.

Interface 304 indicates interrelated systems that maybe utilized by practices as a result of the older PMSs, clinical or dental systems not being sophisticated enough to handle other key functions of the practice. Interface 304 helps with the customer relationship management aspects, the accounting functions, and other enterprise resource planning requirements such as inventory management, human resource management, and payroll.

CRM 340 is a customer relationship management system being utilized in the practices. These systems would contain modules to help the sales and marketing functionalities. Leads management, opportunities management, and sales workflow management would be some of the modules. Also, client level service requests tracking could be enabled using a case management module. These would be some of the key methods adopted to track the quality of patient care. Since this would be some of the information that the practice manager might need to deep dive into further, this information could also be connected to the present invention using the same data connectivity mechanisms described above SQL 330, DB 332, Reports 334, Data Source Connection 336, Reporting Server 338, and Data Sync 348).

Accounting Package 342 is a separate accounting package that may be maintained by the client to track their income and expenses. These systems would have the following modules: (1) Accounts Receivable for invoicing and cash receipts in sales, (2) Accounts Payable to track the outstanding invoices and payments due by the practice, and (3) General Ledger that would record all the account information, budgets, recurring payments, and receivables. Since these systems would interface data into the present invention to support explorable dashboards to deep dive into the numeric performance of the practice.

ERP 344 is an enterprise resource planning system that is utilized to track the sales orders generated against the inventory, purchase orders to track the purchase requirements of the practice against the current inventory levels, and inventory management to highlight the stock on hand and storages. They would also cover the modules in an accounting package 342 or CRM 340. These systems integrate data and information into the system disclosed in this invention.

Related Systems 346 is understood in the industry as being a variety of systems that are utilized by the numerous providers. Any system that has the connectivity capabilities discussed above could be integrated with the present invention to make more meaningful dashboards pertaining to the practice. These have been cumulatively referred to as other related systems.

Extract 306a and Export 306b subroutines extract, export and connect the data elements of these external systems to the inventions. The subroutines extract or export through means of front end reports 334, or directly using data source connections 336 connecting to the backend databases either SQL 330 or other databases DB 332 of these systems in Healthcare Systems 302 or Interface 304. Some of the more complex databases may require data and information to be converted and loaded to a reporting server 338 using some form of drivers.

Practice data 316a relates to appointments, verification of benefits, eligibility, pre-authorization, demographic entry, visits, coding, billing, claims submission, payments posting, denial management, collections and patient billing processes. The raw medical data that is pulled out also needs to meet the HIPAA legal requirements if it is hosted in any other location. Hence, the current invention pulls only de-identified non protected health information (PHI) to the SQL Server 350 which could be cloud hosted or centrally hosted.

This practice raw data needs to be collected in some form in order to map on the SQL Server 350 that may be cloud-hosted or centrally hosted, and to calculate and integrate using the ETL Process 308 so it could be finally displayed and driven out to the dashboards 312a-312n. To map is to identify the primary keys in the various data elements one to one and provide accurate output The mapped data would be loaded to the SQL Server 350. This would then be converted to the user interface that could be viewed by the user 323, mainly medical services providers. The conversion would be done using computer programming and transformational formulae.

Structured Query Language (SQL) 330 is a database that stores raw medical services data. The SQL database would store real time data of the practice management system. This data is retrieved and converted to be loaded into the cloud or central server.

Other databases 332 also store raw medical services data. This refers to any other database format other than MS SQL. These are more complex databases that require something more than a direct ODBC based or OLE.db based. Depending on the complexity a reporting server may be introduced to complete the connection.

Up Front Reports 334 would be one source mechanism that would help pull out raw medical services data. These are the reports generated using reporting tools inbuilt in the PMS, clinical or interrelated systems. These at certain instances could be extracted to .csv or similar forms and synced in order to continuously extract these on a periodic basis at time a macro program is designed to run recurrently.

Data Source 336 connection is another mechanism that would help collect the raw medical services data ODBC, OLE.db are various data sources that we work with in directly accessing the PMS, Clinical or other related systems to the central or cloud server that stores data in the current invention's application readable format.

Reporting Server 338 collects raw medical services data without PHI. This is a central data repository server. If any adhoc databases are being worked on there are certain instances where these need to be converted to enable the data sync process. The converted data would be stored in a secure repository called the reporting server.

Data Sync 348 subroutine maps practice data 316a or financial data 318a and syncs that data to be loaded into the SQL server 350. The primary key to be identified in the various data elements is to map the data one to one and provide an accurate output.

The raw medical services data 350 collected from the various healthcare systems 302 or other related systems 304 would need to be loaded or stored in a central data repository. This is generally hosted in a cloud server and is maintained as a SQL server 330.

Raw medical services data 316b is connected to upfront reports 334, data source connections 336, SQL 330 or other database back ends. Reporting server would need to be loaded to the SQL server 350. This is integrated in line with the application server to provide the dashboard output of the invention.

The raw medical services data 316a is loaded into the SQL server 350 and that data needs to be transformed to application readable format we could state is the second set of medical services data. The conversion or the extract load transform (ETL) process would be done using computer programming and transformational formulae.

Application Server 310 is where the computer program or the application resides. The application is hosted on a software as a service model. The user is usually a medical services provider, and would interact with the application in viewing the user interfaces or in this case the dashboards. This is an application that is hosted via the web. The second set of medical services data i.e. the raw medical services data transformed using transformational formulae or programming language, would then be displayed to the user on the user interface dashboards 312a-312n as dashboard data.

ETL 320 data refers to the data that has been converted to application readable format using a means of transformational formulae. Raw medical services data that has been or is being extracted, transformed, loaded, and converted to final set of integrated medical services data would then be displayed on the user interfaces or dashboards 312a-312n.

Dashboards 312a-312n are the interactive user interfaces provided to the user to help them perform self-exploratory, agile analytics. This is where the user would be able to view the final form of the integrated medical services data set for their perusal. The data would be displayed in a format that is easy and covers the holistic revenue cycle management process and/or other related systems' processes. On the revenue cycle management angle, there would be the dashboard tab giving a snapshot of the practice performance, closely followed by the appointments tab that would display data pertaining to the appointments scheduled at the practice. Next it would be the submission and production data that would outline the claims submission data and the charges per claim.

This would be closely followed by the deposits tab that would display the data captured in the PMSs and related systems relating to the payment received for the claims that were submitted. Aging revenue and reimbursements, denial trending and CPT and payer mix details would be displayed in the next tabs, outlining the claim details. All this information help a practice manager to understand the status quo, the strengths, weaknesses, opportunities and threats prevalent to the practice and make decisions, corrections, and other investments with a strong footing. All these tabs have the ability to drill down and generally in a manner of three clicks a user would find out the answer to the analytic question he has. The details of these are discussed in the upcoming sections where each and every tab and its uses are described in detail.

Financial data 318a-318b is accounting related information captured in the accounting packages, ERPs or similar systems such as. The order entry, purchase order, inventory management, accounts receivable, accounts payable and general ledger information. This information is key in arriving at the position of the organization's finances and the net change in the organization's finances. This would provide the outline of the cash flow situation of the practice, and hence, it would be ideal to look at this alongside the healthcare revenue cycle information captured in the PMS 324a and PMS 324b. The practice manager would be able to view the revenue and cost information pertaining to the practice in one view.

Dashboard Data 322 is the ETL Data 320 that would be displayed on the application server, accessible to the user over wide area network or internet. Data is presented to the user in a specific manner for the user to be able to easily use, including examination of revenue cycle management and related analytics environment. The data would include both a mix of figures and graphical representations to enable the user to easily understand the data.

User 323 is the person who would interact with the user interface or the dashboards. When it comes to the revenue cycle setting, the user would most probably be a medical services provider or a third party helping the medical services provider. The User 323 needs to be able to understand the large volume and complexity of the raw medical services data. Hence, the current invention's data hosted on the SQL server 350 and the user interface hosted on the application server 310 has been manipulated using transformational formulae in such a way it would be easily readable and understandable by the user, so that the user would be able to self explore and interact with the user interfaces to a great extent without consuming too much time in the process.

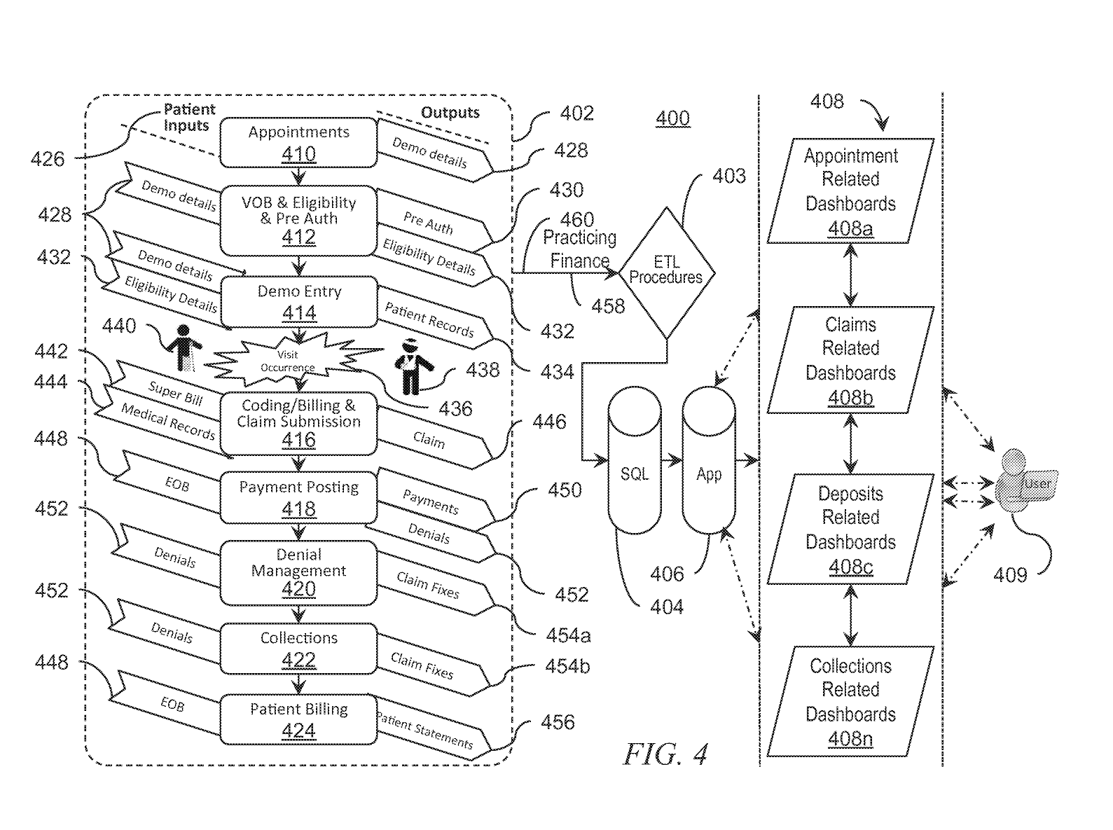

With regard to FIG. 4, a healthcare workflow 400 including operations and data generation of a medical service provider is shown. The workflow 400 may include generating dashboard user interface data for the medical service provider to view on a dashboard user interface utilizing the principles of the present invention. The workflow 400 may include a medical service provider workflow 402, ETL procedures 403, SQL database 404, and application server 406. As previously described, the ETL procedures 403 may be configured to extract, transform, and load practice and financial data generated by healthcare management system(s), financial system(s), and data collection system(s). The application server 406 may be configured to process and/or manage dashboard data for display on electronic devices (not shown) for displaying various dashboards 408. The dashboards 408 may include appointment related dashboards 408a, claims related dashboards 408b, deposits related dashboards 408c, and collections related dashboards 408n. It should be understood that additional and/or alternative dashboards may be available for display based on data collected and processed from the healthcare management systems, financial systems, or other systems that may be utilized by medical service provider. The dashboards 408 may be interactive and dynamic for the user 409.

The medical provider workflow 402 may include a number of different processes that may be performed by a healthcare or practice management system (see FIG. 3B), including setting appointments 410, verification of benefits (VOB)/eligibility/preauthorization 412, and demographic entry 414. A practice management system (see FIG. 3B) may include the processes of coding/billing and claims submission for 416, payment posting 418, denial management 420, collections 422, and patient billing 424.

PMS 402 is used to primarily manage the practice's administrative and revenue cycle process and for the capture of raw medical services data that would be utilized in the current invention. The revenue cycle management process starts with the patient scheduling a visit to the clinic, facility or hospital and proceeds with the appointment information capture, verification of benefits, eligibility and pre-authorization of the patient, demographics data collection and entry into the practice management system, patient visit, coding, billing and claims submission, payment posting, denial management, and collections through to patient billing.

By effectively and efficiently managing this process, the physician, doctor or hospital facility is able to enhance the revenue generation process and maintain or grow the status quo of the practice. The current invention is designed to primarily cater to medical services provider and related users to optimize practice management. The input items for the present invention need to be keyed into the system by a user which would be processed within the system and there would be output.

During the patient scheduling process, key information would be captured and input into the PMSs appointments module. Next the provider representative would verify the benefits and eligibility of patient and secure a pre-authorization from insurance plan as a best practice. The patient demographics data collection and entry into the PMS would be next.

During the visit physician would record diagnosis and procedure related information on a super bill. This would be used to code, bill and submit claims through the PMS. Next, the insurance carrier processes the claim. They may either reject it, pay it in full or partially pay. This information would then be sent in the form of an electronic remittance advice (ERA) or explanation of benefits (EOB), and the user would post the EOB into the PMS. The claims would be monitored based on their outstanding status from the date they were billed out or the date of the actual patient visit. The outstanding claims that were rejected or short paid in the PMS would be the accounts receivable balance. The rest of the balance would be collected using frequent follow up, and denial fixes. At certain instances the patient would be billed for a balance on the claim, and the patient statements would be generated and sent out.

As appointments 410 are a starting point of patient care, patient inputs 426 may be received for scheduling an appointment. Output from the appointments process 410 may include demographic details 428. The demographic details 428 may be an input into the process 412, which may output preauthorization 430 and eligibility details 432 for the medical service provider to ensure that the patient is covered and has authorization for the medical service provider to perform services for the patient. The demographic details 428 and eligibility details 432 may be imports to the demographic entry process 414 from which patient records 434 may be generated. A visit occurrence 436 of a patient 438 with a medical service provider 440, such as a medical doctor, may occur after the patient records 434 have been created.

Appointments 410 is the initial stage of the revenue cycle management process 402. When the patient calls, there would be a process followed to capture the key appointment related raw medical services information into the system. This is mainly the insurance plan information and applicable patient demographic information. This would result in a patient and appointment record being created in the PMS 402. Appointments could be analyzed based on their type or time period (i.e., whether they are past, present or future; based on scheduled vs. cancelled). The input would be details collected during the patient call/visit and the output would generally be the demographic information entered into the PMS 402.

Demo Tab 428 shows all demographic details of a patient, e.g., name, address, SSN, DOB, email, fax, and phone. These would be an output that would come out of the appointments process. It would also be the input details to capture in the VOB, eligibility and pre-auth processes and the demo entry process.

VOB, eligibility and pre-auth processes 412 is the process whereby the provider and their representatives verify that the patient is eligible for pay for a particular medical service by the carrier or insurance plan. The demo details and the insurance card information collected from the patient during their appointment and similar raw medical services would be the input to help with the verification of benefits and eligibility process. Verification of benefits and eligibility is where we need to cross check with the insurance carrier whether the patient's plan is eligible for pay of a particular service patient is about to receive and physician is about to submit claim for.

During this process one ascertains with the carrier whether the patient is eligible for full coverage or whether he/she needs to pay a copay, coinsurance, and deductible. Pre-auth is where we get a form signed off by patient pre-authorizing the physician office to process a claim and collect payment on his behalf. The output of this process will be the eligibility details outlined by the carrier and the pre-auth they may provide in conjunction with the patient.

Pre-auth 430 shows records of documents signed off by the patient in conjunction with the insurance authorizing the facility to process claims. This is not always a mandatory output from the VOB, eligibility and pre-auth process, but is sometimes mandatory based on the type of insurance plan. It would also be fed into the patient master records along with the other eligibility details 432.

Demo Entry 414 is when the patient makes a scheduled call or visit and the physician office or similar representative collects all patient demographic and insurance plan information and similar raw medical services and inputs same into the practice management system. At the end of the process, the PMS would have a master record created for the patient with all relevant details.

Patient Records 434 are the patient master files that are generated and saved in the system when the demo details are entered to same. They are the output of the demo entry process 414.

Patients 426, 438 and 440 are the sick and injured who visit the practice, facility or hospital for treatment.

Visit 436 is when the patient visits the facility to obtain services as scheduled during the appointment making process. This main occurrence would be the key in the preceding steps or processes taking place and being recorded in the PMS.

Super Bill 442 is the prescription document filled in by the doctor during the patient visit. The diagnosis and services rendered are marked on the Super Bill. Services rendered are shown using HCPCS or CPT codes. This would facilitate and input items that would help the coding, billing and claims submission process.

Medical Records 444 are a more detailed description of the patient's condition that doctors may provide. These in turn would facilitate and input items that would help the coding, billing and claims submission process.

Coding, billing and claims submission 416 is where the services rendered are coded and billed out on a claim using the super bill that the medical records provider submits during patient visit. Finally, the claim is sent out to the insurance company via a practice management system and clearing house system. The clearing house system is an intermediary between the PMS 402 and the insurance carrier's system.

Claims 446 are the standard documents submitted to the insurance companies by the physicians or providers outlining the services rendered and the related details along with a charge to be paid. These need to go in the standard format required by the state further to the introduction of the CMS 1500 form. It would capture patient, insurance, diagnosis, procedure, and other key raw medical services information required to process the claim.

Payment Posting 418 takes place based on received forms of explanation of benefits, and it outlines the check or other payment medium information, the payment amounts, the procedures paid, and unpaid amounts and why. This information would be entered into the practice management system against the entered claim and offset the due amount to the physician or practice. EOBs could reflect a payment or a denial.

EOB (explanation of benefits) 448 is a detailed form that is provided by the insurance companies outlining the payment or denial summary. This would be the input item used to enter the payment received in the posting process 418.

Payments 450 are the actual payment amounts processed by the insurance companies: full or partial payments agreed to be paid on a claim by the insurance company.

Denials 452 are the refusals to pay by the insurance company. They generally state reasons for refusal such as not medically necessary, past timely filing deadline, and similar as reasons for not paying the claims submitted. These are the inputs to start the denial management process 420.

Denial management 420 commences when the insurance carrier denies the claim in some form as unpayable on certain grounds. These denials would need to be fixed. The denials would also be entered into the system via the EOBs.

Claim fixes 454a-454b are the fixes that the providers or those who work on behalf of the providers make in order to fix and resubmit the claim. This resubmission could be a corrected claim or an appeal of sorts. These would be the steps that the collector or the person in charge of denial management would make on the claim to get it paid properly and accurately.

Collections 422 ensures that all denied, short paid and non-paid amounts are accurate. If this is not the case the follow up on same would take place using a denial fixing process. The collections follow up would be based on the PMS transactions entered so far. The collector would review the claim from the appointment through to the payment or denial stage to identify the next steps that would be undertaken to get the claim paid.

Patient billing 424 occurs when the carrier (primary, secondary and tertiary depending on the scenario with the patient concerned) has exercised all payments per the plan and policies and the remaining amount is to be bourne by the patient in the form of copay, coinsurance, and deductible. Patient statements showing the patient balances would be sent out periodically.

Patient statements 456 are records of statements outlining the amount due from the patient. This would be a summary of the full insurance payments and then provide the balance due by patient. These are the output reports from the patient billing process 424.

After the visit occurrence 436, a super bill 442 and medical records 444 may be submitted into the coding/billing and claims submission process 416. Resulting from the process 416 are claims 446 that are typically submitted to an insurance company. An explanation of benefits (EOB) 448 may be submitted to the payment posting process 418, and payments 450 and/or denials 452 may be output therefrom. The denials 452 may be submitted to the denial management process 420 and claim fixes 454a may be generated for resubmission to the insurance company. Additionally, the denials 452 may be submitted to the collections process 422 and claim fixes 454b may be output before the submission to the insurance company. The explanation of benefits 448 may be incorporated into the patient billing 424, and patient statements 456 may be issued to the patient. It should be understood that the workflow 402 is illustrative and additional and/or alternative processes may be performed in accordance with the principles of the present invention. It should also be understood that the processes may be in a different order. Still yet, the process 402 may be different for different medical service provider types, such as general medical practitioners, specialists, dentists, physical therapists, or other medical service provider.

Practice data 458 and financial data 460, which may be outputs of the processes of the workflow 402, may be processed by the ETL procedures 403. The appointment related dashboards 408a may provide various data related to appointments, including appointments made and canceled, demographic details associated with the appointments, amount of money lost as a result of canceled appointments, and so on. The claims related dashboards 408b may provide information related to insurance claims, such as amount of particular types of insurance claims, total number of claims, claims related to particular medical conditions, and so forth. The deposits related dashboards 408c may provide information associated with deposits, such as total number of deposits, deposits associated with certain patient demographics, deposits associated with certain medical providers, deposits associated with treatment facilities, and so forth. The collections related dashboards 408n may provide for information related to collections, including collections from particular insurance companies, outstanding collections, collections associated with patient demographics, collections associated with individual medical service providers, and so on.

As will be presented further herein in association with specific dashboard views, the dashboards 408 operate as a data discovery tool for medical service providers. In addition, the dashboards enable a medical service provider to answer nearly any question related to revenue cycle management and/or other workflows in a minimal number of “clicks,” such as three or four. Moreover, the dashboards 408 may provide access to claim-level detail or other lowest-level detail to assist the medical service provider in answering questions for managing a medical practice.

The raw medical services data (410, 412, 414, 416, 418, 420, 422 and 424) that was loaded into the SQL Server 404 would need to be transformed to application readable format we could state is the second set of medical services data. The conversion or the extract load transform (ETL) process would be done using computer programming and transformational formulae.

The raw medical services data that was fed into the PMS 402 through a variety of connectivity and extraction mechanisms discussed in FIG. 1 is loaded to a SQL server 404 that would reside on a cloud or central setting. This data would then be converted through a variety of transformational formulae and ETL procedures 403 to a secondary set of medical services data that would be readable by the application and displayed out via interactive user interface dashboards 408a-408n.

Application server 406 is where the computer program or the application resides. The user being a medical services provider in most cases, would be interacting with the application in viewing the user interfaces or in this case the dashboards. This is an application that is hosted via the web. The second set of medical services data, i.e., the raw medical services data transformed using transformational formulae or programming language, would then be displayed to the user on the user interface dashboards 408a-408n as dashboard data.

All the integrated medical services data displayed in the dashboards 408 have been cumulatively referred to as dashboards in this scenario. It could be categorized at a very high level as appointment related dashboards 408a, claims related dashboards 408b, deposits related dashboards 408c and collections related dashboards 408n.

Appointment related dashboards 408a include the appointment and is one of the primary steps in the revenue cycle management process. It is an area that needs management. All data captured in the PMS at the appointments stage 410 would be connected to and the secondary medical services data would be made available in the form of interactive dashboards for the user's analysis.

Claims 408b related dashboards include the claims submission, charges entered, CPTs billed, and would be other relevant information that needs to be monitored. All of these related dashboards have been cumulatively called claims related information.

Deposits 408c related dashboards are linked to the claims payments and display the key revenue tracking needs for a practice at any given time. The variety of deposit related information tabs are cumulatively called deposit related dashboards in this document. Most of the information captured in the payment posting stage 418 would be converted secondary medical services data set to be displayed in these dashboards.

Collections 408n related dashboards relate to the pending payments or the to-be collected claims related information. These would be named the collections related dashboards in this context. Raw medical services data captured in VOB, eligibility and pre-auth 410, demo entry 412, coding, billing and claims submission 416, denial management 420, collections 422, and patient billing 424 would all be integrated to develop the set of collections related dashboards.

The user 409 is the medical services provider or similar person who would interact with the dashboards 408 and analyze the practice performance. It is one of the key stakeholders in the use of the current invention.

FIG. 4 outlines the detailed functionalities of the PMS and the raw medical services data inputs and outputs of each functionality. The functional integration points from appointments 410, VOB, eligibility and pre-auth 412, demo entry 414, coding, billing and claims submission 416, payment posting 418, denial management 420, collections 422 to patient billing 424. These raw medical services data would be converted to a secondary level of medical services data through a variety of unique transformational formulae to a be loaded to a SQL cloud server 404 and hosted on an application server 406 that would output or display the user interface dashboards that would at a high level be dashboard groups being appointment related dashboards 408a, claims related dashboards 408b, deposit related dashboards 408c and collections related dashboards 408n.

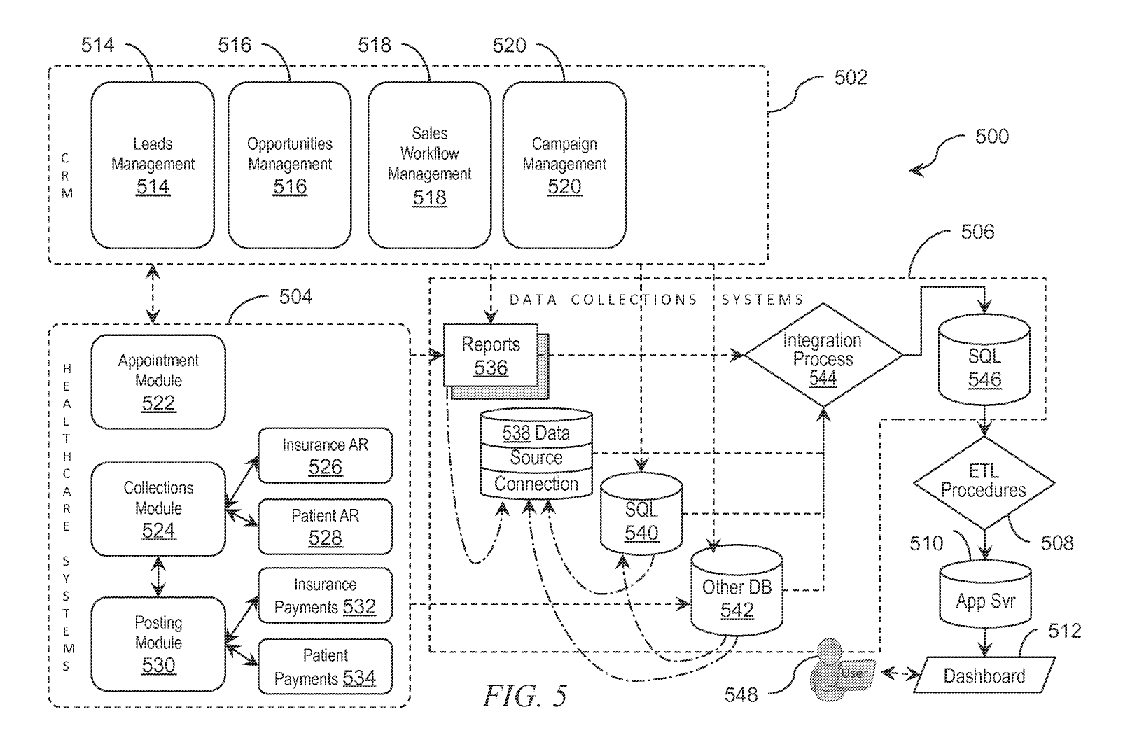

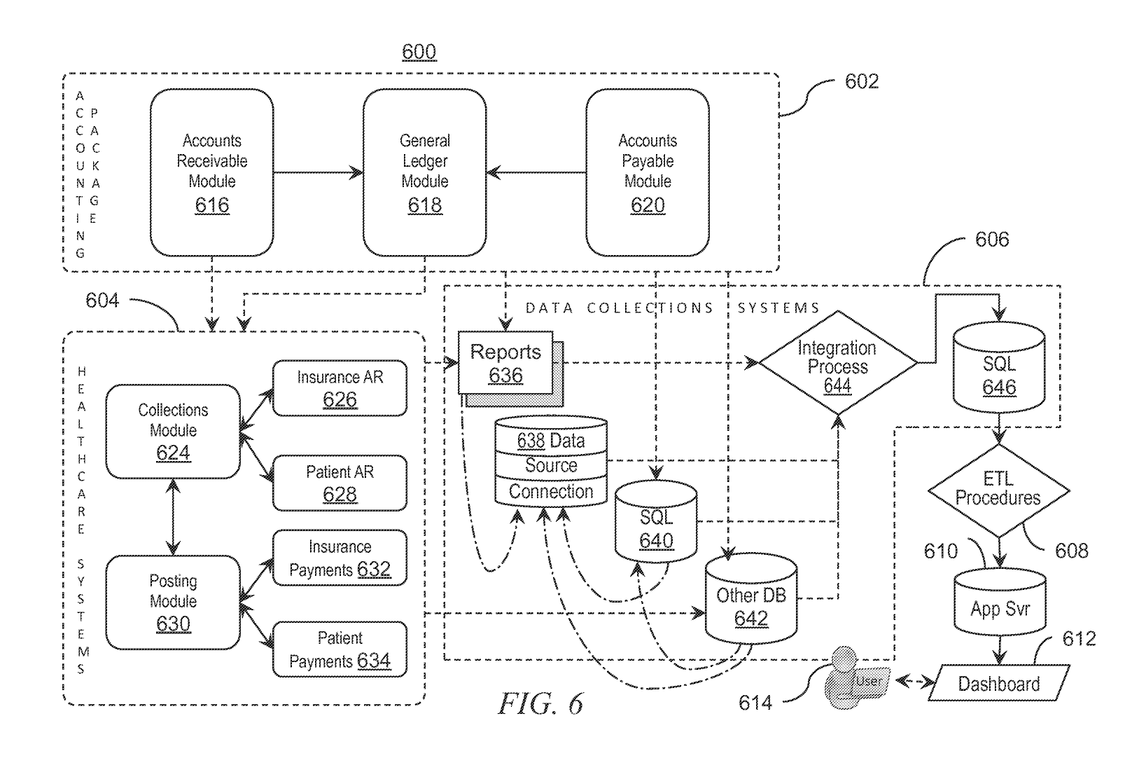

With regard to FIG. 5, a detailed block diagram of system 500 configured to generate healthcare analytics inclusive of customer relationship management (CRM) data for presentation on a dashboard user interface is shown. The system 500 may include a customer relationship management system 502, healthcare or practice management system(s) 504, data collection systems 506, ETL procedures 508, and application server 510 configured to drive a dashboard 512.

The CRM system 502 may include a number of different modules, including a leads management module 514, opportunities management module 516, sales workflow management module 518, and campaign management module 520, as understood in the art. Each of these modules 514-520 are generally used in combination to drive sales for a medical service provider to acquire and maintain patients (i.e., customers) of the medical service provider. As shown, information from the CRM system 502 may be shared with the healthcare management system 504 and data collection systems 506.

The healthcare management systems 504 may include an (i) appointments module 522, (ii) collections module 524, which may be utilize to track insurance accounts receivables 526 and patient accounts receivables 528, and (iii) posting module 530, which may utilized to track insurance payments 532 and patient payments 534. In one embodiment, data collected from the CRM module 502 by the healthcare management systems 504 may be used to populate data records of the healthcare management systems 504 to minimize integration efforts for the medical service provider.

The data collection systems 506 may collect data of reports 536 (e.g., Excel spreadsheets), data source connection 538 that may be configured to connect various data sources, such as the reports 536, SQL database 540, other database 542, and so on. An integration process 544 may be configured to receive and/or access the report data and collection systems 536-542 in the data collection systems 506 and input or otherwise populate the data into another SQL database 546. It should be understood that additional and/or alternative data collection systems and protocols may be utilized in accordance with the principles of the present invention. For example, the reports 536 and data source connection 538 may be configured on independent computing devices or integrated into computing devices performing other processes, as well.

The ETL procedures 508 may be configured to access data stored in the SQL database 546 and process that data to generate dashboard data from the application server 510. The application server 510 may thereby be available for presentation on the dashboard 512 for a user 548 to view, as further presented herein.

A CRM system 502 and a PMS 402 have data that is extracted or connected to, integrated and synced to the database and application server requirements to display the dashboards. FIG. 5 details the healthcare PMS and the practice's CRM systems integration process using one of a variety of data collection methods such as reports 536, data source connections 538, SQL server connections 540 and other database connections 542 displayed as dashboards.

Data collection system 506 receives various forms of data for retrieval and collection procedures utilized to extract or connect to the data available in the PMS 402, clinical or related systems. Collection/retrieval methods use up front reports 536, data source connections 538, direct connectivity to the SQL backend database 540 or connectivity to other databases 542.

Up Front Reports 536 is one source mechanism that would help pull out the raw medical services data. These are the reports generated using reporting tools inbuilt in the PMS, clinical or interrelated systems. These at certain instances could be extracted to .csv or similar forms and synced. In order to continuously extract these on a periodic basis at time, a macro program is designed to run recurrently.

Data source connection 538 is another mechanism that would help collect the raw medical services data. ODBC, OLE.db are various data sources that work directly with accessing the PMS 402, Clinical or other related systems to the central or cloud server that stores data in the current invention's application readable format.

Structured Query Language (SQL) 540 databases store raw medical services data. Some practice management systems come with a MS SQL backend database. The SQL database would store real time data of the practice management system. This data is retrieved and converted to be loaded into the cloud or central server. It is one of the easier database structures that is available.

Other databases 542 also store data that store raw medical services data. This refers to any other database format other than MS SQL such as Oracle, DB2. These are more complex databases; hence, these may require something more than a direct ODBC base or OLE.db base. Depending on the complexity, a reporting server may be introduced to complete the connection.

Extract, transform and loading processes ETL 508 would take place when the data collected from a practice management or other related system needs to be converted using transformational formulae to a second set of medical services data that would be in the application readable format.

Application server 510 is a computer program where the application program is executed. The user 548 being a medical services provider in most cases would be interacting with the application in viewing the user 548 interfaces or in this case, the dashboards 512. This is an application that is hosted via the web. The second set of medical services data, i.e., the raw medical services data transformed using transformational formulae or programming language, would then be displayed to the user on the user interface dashboards 512.

Dashboards 512 are the user interfaces used to display the data in an interactive manner. All the integrated medical services data displayed in the dashboards have been cumulatively referred to as dashboards in this scenario. If the PMS and the CRM systems are integrated, the dashboards would display information pertaining to both systems. Detailed analysis of all the hosted information would be feasible using the interactive dashboards.

Leads 514 and opportunities 516 management is a vital component of any CRM system 502. These management subroutines track the potential sales leads and the various stages it is in, how long it has been outstanding, what action has taken place, and when it is expected to close.

Sales workflow 518 and campaign 520 management is the management of the whole sales cycle and the steps taken to manage a marketing or sales campaign.

The healthcare system 504 helps administer the practice performance and the revenue cycle management function of a practice is described. Appointments 522 module received the appointment related information that is keyed into the PMS 402. The appointment is one of the primary steps in the revenue cycle management process. It is an area that needs management. All data captured in the PMS pertaining to the appointments would be captured as discussed in FIG. 4.

Collections 524 module receives the claim related information that is keyed into and resides in the PMS 402. Collections 524 relate to the pending payments or the to-be-collected claims related information. Raw medical services data captured in VOB, eligibility and pre-auth, demo entry, coding, billing and claims submission, denial management, collections, and patient billing would all be integrated to collections module which would look into all of the raw data to understand the outstanding claims.

Insurance AR 526 is the collectible component from the insurance carriers. The total aging revenue of the claims would be comprised of insurance and patient AR. This is the component that the practice manager needs to be most mindful of in the collections process.

Patient AR 528 is the collectible component from the patients. The total aging revenue of the claims would be comprised of insurance and patient AR. This is the component that the practice manager needs to be mindful of, and whenever feasible, to collect same upfront before the visit occurs during scheduling process.

Posting module 530 tracks the payments received into the PMS. The EOBs and ERAs received would be posted into the system against the claims outstanding. This would ideally set off the claims outstanding balances overtime.

Insurance payments 532 are payments made by the insurance carriers. This is the component that the practice manager needs to be most mindful of in the collections process.

Patient payments 534 are payments made by the patients. This is another component that the practice manager needs to be mindful of and whenever feasible to collect same upfront before the visit occurs during scheduling process.

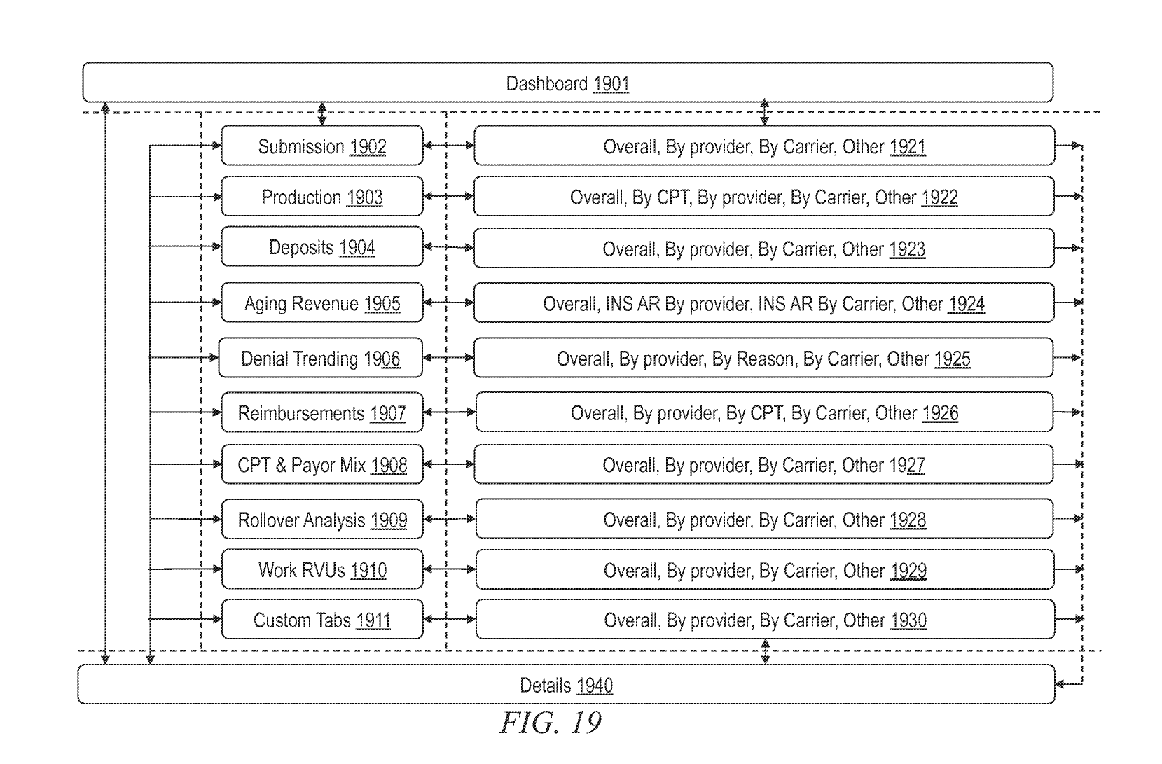

The user 548 is the medical services provider or similar person who would interact with the dashboards and analyze the practice performance. This is one of the key stakeholders in the use of the current invention. Users of medical systems would need to deal with large volumes of data and many procedural complications. Hence, the current invention facilitates as a self exploratory tool that allows users to question and deep dive into the data following their thought process at any given time. FIG. 19 would describe in detail the interactions between the various tabs and how it could be manipulated by the user at any given time.

With regard to FIG. 6, a detailed block diagram of system 600 configured to generate healthcare analytics inclusive of accounting data of the medical service provider for presentation on a dashboard user interface is shown. The system 600 may include an accounting package 602, healthcare or practice management system(s) 604, data collection systems 606, ETL procedures 608, and application server 610 configured to drive a dashboard 612.

The accounting package 602 may include a number of different modules, including an accounts receivable module 616, general ledger module 618, and accounts payable module 620, as understood in the art. Each of these modules 616-620 may be used in combination to handle accounting for a medical service provider. As shown, information from the accounting package 602 may be shared with the healthcare management system 604 and data collection systems 606.

The healthcare management systems 604 may include (i) a collections module 624, which may be utilized to track insurance accounts receivables 626 and patient accounts receivables 628, and (ii) posting module 530, which may utilized to track insurance payments 632 and patient payments 634. In one embodiment, data collected from the accounting package 602 by the healthcare management systems 604 may be used to populate data records of the healthcare management systems 604 to minimize integration and accounting efforts for the medical service provider.

The data collection systems 606 may collect data of reports 636 (e.g., Excel spreadsheets), data source connection 638 that may be configured to connect various data sources, such as the reports 636, SQL database 640, other database 642, and so on. An integration process 644 may be configured to receive and/or access data the reports data and collection systems 636-642 in the data collection systems 606 and input or otherwise populate the data into another SQL database 646. It should be understood that additional and/or alternative data collection systems and protocols may be utilized in accordance with the principles of the present invention.

Patient payments 634 are payments made by the patients. This is another component that the practice manager needs to be mindful of and whenever feasible to collect same upfront before the visit occurs during scheduling process.

FIG. 6 shows the Accounting package and the PMSs overview modules and the integration process further to collection data from the two data repositories that may be reports 636, data source connections 638, SQL database connections 640 or other database connections 642.

The healthcare system 604 helps administer the practice performance and the revenue cycle management function of a practice is described. Appointments 622 module received the appointment related information that is keyed into the PMS 402. The appointment is one of the primary steps in the revenue cycle management process. It is an area that needs management. All data captured in the PMS pertaining to the appointments would be captured as discussed in FIG. 5.

Collections 624 module receives the claim related information that is keyed into and resides in the PMS 402. Collections 624 relate to the pending payments or the to-be collected claims related information. Raw medical services data captured in VOB, eligibility and pre-auth, demo entry, coding, billing and claims submission, denial management, collections, and patient billing would all be integrated to collections module which would look into all of the raw data to understand the outstanding claims.

Insurance AR 628 is the collectible component from the insurance carriers. The total aging revenue of the claims would be comprised of insurance and patient AR. This is the component that the practice manager needs to be most mindful of in the collections process.

Patient AR 628 is the collectible component from the patients. The total aging revenue of the claims would be comprised of insurance and patient AR. This is the component that the practice manager needs to be mindful of, and whenever feasible, to collect same upfront before the visit occurs during scheduling process.

Posting module 630 tracks the payments received into the PMS. The EOBs and ERAs received would be posted into the system against the claims outstanding. This would ideally set off the claims outstanding balances overtime.

Insurance payments 632 are payments made by the insurance carriers. This is the component that the practice manager needs to be most mindful of in the collections process.

Patient payments 634 are payments made by the patients. This is another component that the practice manager needs to be mindful of and whenever feasible to collect same upfront before the visit occurs during scheduling process.

The user 648 is the medical services provider or similar person who would interact with the dashboards and analyze the practice performance. This is one of the key stakeholders in the use of the current invention. Users of medical systems would need to deal with large volumes of data and many procedural complications. Hence, the current invention facilitates as a self exploratory tool that allows users to question and deep dive into the data following their thought process at any given time. FIG. 19 would describe in detail the interactions between the various tabs and how it could be manipulated by the user at any given time.

Data collections systems 606, receives various forms of data for retrieval and collection procedures utilized to extract or connect to the data available in the PMS 402, clinical or related systems. Collection/retrieval methods use up front reports 636, data source connections 638, direct connectivity to the SQL backend database 640 or connectivity to other databases 642.

Up Front Reports 636 is one source mechanism that would help pull out the raw medical services data. These are the reports generated using reporting tools inbuilt in the PMS, clinical or interrelated systems. These at certain instances could be extracted to .csv or similar forms and synced. In order to continuously extract these on a periodic basis at time, a macro program is designed to run recurrently.

Accounts receivable module 616 in the accounting package 602 would be the component where the customer related invoices and payments are captured. These would also have the functionality to identify and track client demographics, credit notes, debit notes, prepayments, and overpayments. It would closely integrate with the General Ledger module. The invoice created in the AR module would create an increase in the debtors control account debit balance in the GL.

The general ledger 618 is the host of all the chart of accounts. Account information and maintaining of the balances would be done through this module with the objective of finally deriving the daily account balances, budgeting, and preparation of the final accounts.

The accounts payable module 620 would analyze and maintain the vendor related information, such as the vendor demographics, the invoices, and payments made. This module 670 is also closely in liaison with the GL module 618. An invoice in the AP module 602 would increase the credit amount in the GL vendor control account.

Data source connection 638 is another mechanism that would help collect the raw medical services data. ODBC, OLE.db are various data sources that work directly with accessing the PMS 402, Clinical or other related systems to the central or cloud server that stores data in the current invention's application readable format.

Structured Query Language (SQL) 640 databases store raw medical services data. Some practice management systems come with a MS SQL backend database. The SQL database would store real time data of the practice management system. This data is retrieved and converted to be loaded into the cloud or central server. It is one of the easier database structures that is available.

Other databases 642 also store data that store raw medical services data. This refers to any other database format other than MS SQL such as Oracle, DB2. These are more complex databases; hence, these may require something more than a direct ODBC base or OLE.db base. Depending on the complexity, a reporting server may be introduced to complete the connection.

Extract, transform and loading processes ETL 608 would take place when the data collected from a practice management or other related system needs to be converted using transformational formulae to a second set of medical services data that would be in the application readable format.

Application server 610 is a computer program where the application program is executed. The user 648 being a medical services provider in most cases, would be interacting with the application in viewing the user 648 interfaces or in this case, the dashboards 612. This is an application that is hosted via the web. The second set of medical services data, i.e., the raw medical services data transformed using transformational formulae or programming language, would then be displayed to the user on the user interface dashboards 612.

Dashboards 612 are the user interfaces used to display the data in an interactive manner. All the integrated medical services data displayed in the dashboards have been cumulatively referred to as dashboards in this scenario. If the other modules (e.g. PMS, Accounting) are integrated, the dashboards would display information pertaining to both systems. Detailed analysis of all the hosted information would be feasible using the interactive dashboards.

Accounts Receivable 616, General Ledger 618 and Accounts Payable 620 are a vital component of any Accounting system 602. These management subroutines track the accounts receivable, payable and revenue and costs information.

Sales workflow 618 and campaign 620 management is the management of the whole sales cycle and the steps taken to manage a marketing or sales campaign.

The ETL procedures 608 may be configured to access data stored in the SQL database 646 and process that data to generate dashboard data for the application server 610. The application server 610 may thereby be available for presentation on the dashboard 612 for a user 614 to view, as further presented herein.

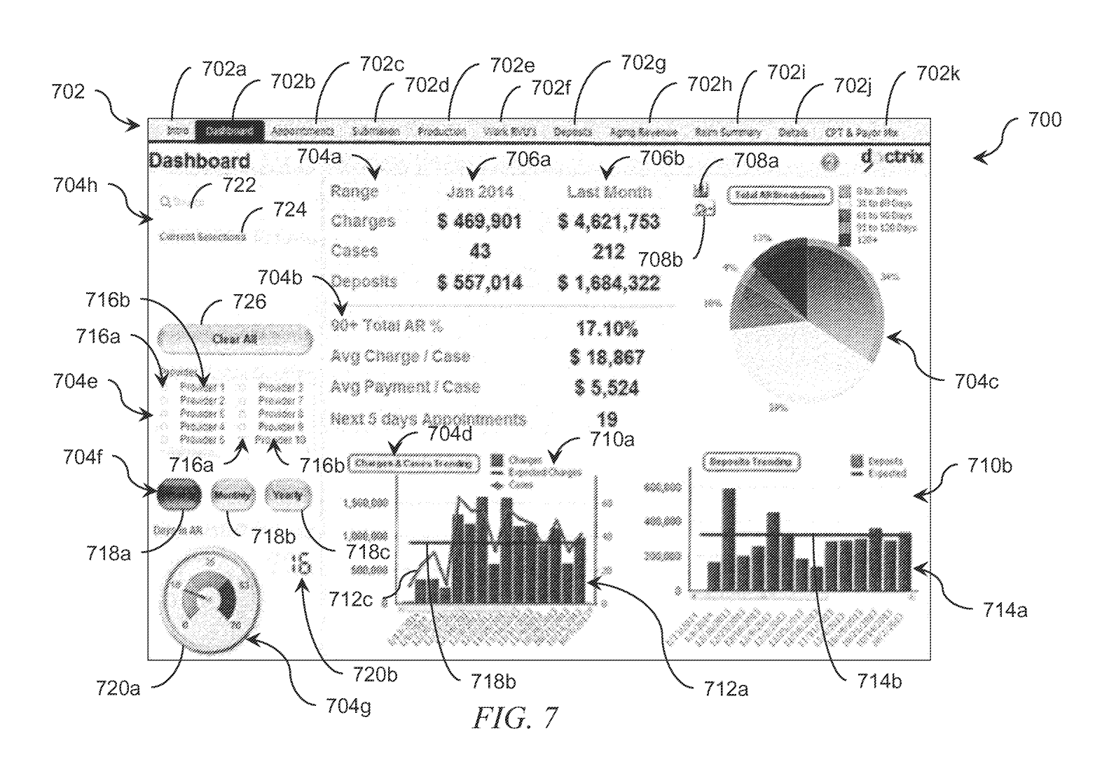

FIG. 7, is an interactive graphical user interface or dashboard 700. The dashboard 700 provides a high-level view of operations of a practice of a medical service provider. The dashboard 700 is configured to present for revenue cycle management of a medical practice, but may also be configured to present cost cycle management of a medical practice if cost data from a financial system tracking costs is integrated with an application server, such as application server 310 (FIG. 3B). The dashboard 700 is configured to enable a user to monitor financial and administrative performance of the medical practice. In monitoring the financial administrative performance, the dashboard 700 enables the user to monitor operational effectiveness, growth, and industry benchmarking. Additional benchmarking may be made available to the user, as well, by the dashboard 700.

A list of tabs 702 provides a workflow for a user in utilizing the dashboard 700. The workflow, in essence, eliminates much of the typical difficulty of conventional reports of healthcare or practice management systems, as understood in the art. The tabs 702 include an introduction tab 702a, dashboard tab 702b, appointments tab 702c, submission tab 702d, production tab 702e, work RVU's tab 702f, deposits tab 702g, aging revenue tab 702h, reimbursement summary tab 702i, claims details tab 702j, and CPT & payer mix tab 702k. By providing the medical service provider with a pre-established set of tabs 702 that provide a workflow, the medical service provider may be able to perform “data discovery” of the medical practice, as opposed to simply obtaining “business intelligence,” as is provided by both conventional practice management systems and conventional analytics tools. The dashboard 700 is displayed in response to a user selecting the dashboard tab 702b. The term dashboard is also descriptive of the user interface inclusive of the overall user interface provided by the workflow as available through selection of each of the tabs 702.

The dashboard screen 700 shows the tabs used to analyze and monitor financial and administrative performance. At a glance we would be able to view the current versus last month 706a, 706b charges, cases and deposit values, 90+ AR percentage, average charge per case and payment per case and the upcoming appointments in X number of days. A practice manager viewing this information is able to make a vast variety of decisions based on the portrayed information. The screen allows this information to be switched from a weekly, monthly to yearly view with a click of a button. There are also some key graphs and trends available that display the actual picture in a user friendly manner. The below 702a-702k are the key processes of a practice's revenue cycle management function. This particular layout was adopted to make it very interactive and easy for the medical services providers use.

Intro page 702a is the landing page of the product outlining a welcome message. It indicates the entity using the dashboard. Dashboard 702 is followed by Tab 702c, Submission Tab 702d, Production Tab 702e, Work RVUs Tab 702f, Deposits Tab 702g, Aging Revenue Tab 702h, Reimbursement Summary Tab 702i, Details Tab 702j, and, the CPT & Payer Mix Tab 702k.

The dashboard is split into two key areas 704h and 704a. The search and selection parameters are available in the left hand side of the dashboard. This is the most suitable format to catch the attention of the user and help user with their self-exploratory analysis. The other right hand section 704a shows the data that is displayed in a user friendly, tabular, easy to read format, with applicable highlights where required.

As further shown in the dashboard 700, a chart 704a that includes columns for current month 706a and previous month 706b to enable a user to view month-over-month performance of various financial and/or administrative categories, such as charges (total value of claims billed), cases (total count of patient visits), and deposits (total deposits received based on date of service), is shown. It should be understood that alternative and/or additional financial and/or administrative performance categories may be presented in the chart 704a. Another chart 704b may include financial and/or administrative performance categories, such as 90+ total AR % (i.e., total to be collected percentage), average charge per case, average payment per case, and next five days of appointments. Additional and/or alternative financial and/or administrative performance categories may be presented in the chart 704b.

This a graphical representation 704c of the total AR which is broken into and shown in the 30, 60, 90, 120, and 120+ days buckets (i.e. the claims cumulative value based on days outstanding from the claims date of service). This is a graphical representation of the 90+ total AR % provided on the dashboard. A total accounts receivable chart 704c may be shown and segmented by accounts receivable over particular time periods, such as in aging “buckets.” A graphical user element 708a enables a user to toggle between chart types, such as bar charts, line graphs, or other chart formats, that the user may select in viewing the accounts receivables in an aging “buckets” format. Graphical user element 708b enables a user to toggle between values and percentages in the chart 704c.

The charges and cases trending is then provided in a graphical manner (on charts and tables 704d & 710a & 712a, 712b, 712c). A comparison between expected charges against the actual is shown along with a linear view of the cases depending on the selection made out of the 718a weekly, 718b monthly, and 718c yearly criteria. Another chart section 704d of the dashboard 700 may include charts 710a and 710b. Chart 710a may show charges and cases trending, including values of charges plotted in a bar graph format 712a by week or other time period, expected charges as a horizontal line 712b, and numbers of cases plotted as a line graph 712c. The deposits trending graph 710b may include deposits plotted in a bar graph format by week or other time period 714a, and expected deposits as a horizontal line 714b to enable a user to measure actual deposits versus expected.

Dashboards 704e & 716a, 716b, 716c, 716d are reviewed based on a specific physician (or similar criteria) if required. A particular physician is selected and the complete dashboard values would display the figures and calculations pertaining to same in a manner of seconds. The dashboard and all other tabs would refresh to the current select in a manner of seconds and help the user to proceed further with their analysis. The dashboard 700 may further provide a number of filters that are selectable by a user. In filter section 704e, a user may select from a number of selectable medical service providers. Selection elements 716a associated with providers 716b enable the user to select one or more providers 716b to view their combined financial and administrative performance in a high-level “snapshot” on the dashboard 700. Although only ten providers are listed, it should be understood that as many medical service providers that are associated with a hospital and/or network of medical service providers, such as a clinic, may be made available for the user to select in filter section 704e.

Tabs 704f & 718a, 718b, 718c allow the user to select between the periodic elements they wish to analyze the dashboards based on. The dashboard and all other tabs would refresh to the current selection in a manner of seconds and help the user to proceed further with their analysis. Section 704f may provide for a user to select selection weekly, monthly, and yearly soft-buttons 718a-718c (collectively 718), to switch among weekly, monthly, and yearly financial and administrative performance data. As a result of the various data collection and processing, dashboard data may be stored in accessible memory for the dashboards. And, because the data may already be stored in accessible memory, as opposed to having to be generated and/or loaded into memory, switching between the various time periods can be nearly real-time in response to selecting one of the soft-buttons 718, thereby making the dashboard 700 (and all other dashboard screens) very fast and easy to use relative to conventional practice management systems that have historically taken days or hours to generate similar information if such similar information could even be generated.

Tabs 704f & 718a, 718b, 718c allow the user to select between the periodic elements they wish to analyze the dashboards based on. The dashboard and all other tabs would refresh to the current selection in a manner of seconds and help the user to proceed further with their analysis. A dial section 704g may display a dial 720a showing a number of days in accounts receivable that it takes the practice or subset of the practice (if being filtered by provider or otherwise) to collect payments from insurance companies or other payers of medical services provided by the medical service provider. In addition to showing a dial 720a, a value 720b may also be displayed so that the user is able to view both the graphical dial 720a and actual value 720b of the days in accounts receivable.

Tab 722 is where user can enter and search any required item. This would retrieve the relevant information that was searched for or return stating search was unsuccessful. All items similar to the search text would begin to display and upon selection the current selected items would get highlighted and displayed in that section. The dashboard 700 additionally provides a search field 722 in which a user may search a variety of different available data, including patient name, provider name, CPT code, facility, or any other data value available within the dashboard as collected from the practice management systems and financial systems of the medical service provider. A current selections section 724 may list a number of filter selections of which the user has selected so that the user knows specifically what filters are being applied for data being displayed on the dashboard 700. The user may select a “clear all” soft-button 726 to clear all of the filters currently being applied to the data to view all available data, as shown.

Column 706a would be the current period practice performance figures. The key performance indicators that would be tracked include the charges, payments and visits for the current month.

Column 706b displays the previous periods' practice performance figures. This would help to understand the current practice standing against the prior period performance in an instant. The key performance indicators that would be tracked are the charges, payments, visits, 90+ AR %, average charge per visit, average payment per visit and appointments coming up in X number of days. These are the key administrative and financial performance indicators that would help a practice manager to comprehensively monitor a practice's operational effectiveness, growth and status quo in terms of industry or specialty benchmarks.

Icon 708a allows the user would be able to switch from the currently shown pie chart to a bar chart. This is reversible again if needed as user desires. Function 708b generates a graph that switches from a percentage based view to a value based view and vice versa.

Deposits charts 710b & 714a, 714b trending graph would display based on the selection criteria made between the weekly 718a, monthly 718b and yearly 718c buttons. This displays a graphical view of the actual versus expected deposits received.

Items displayed 724 in the current selections screen would be the figures that would be displayed across all dashboards and tabs at that given instance. If you want to unselect same you need to hit the 726 clear all button.

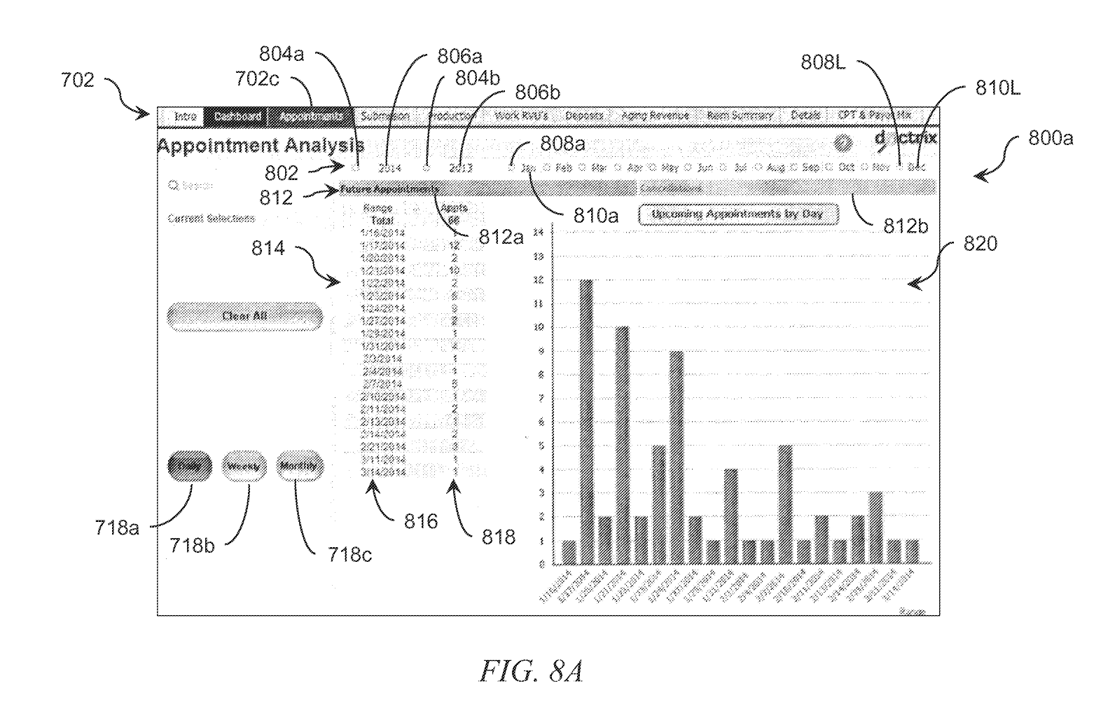

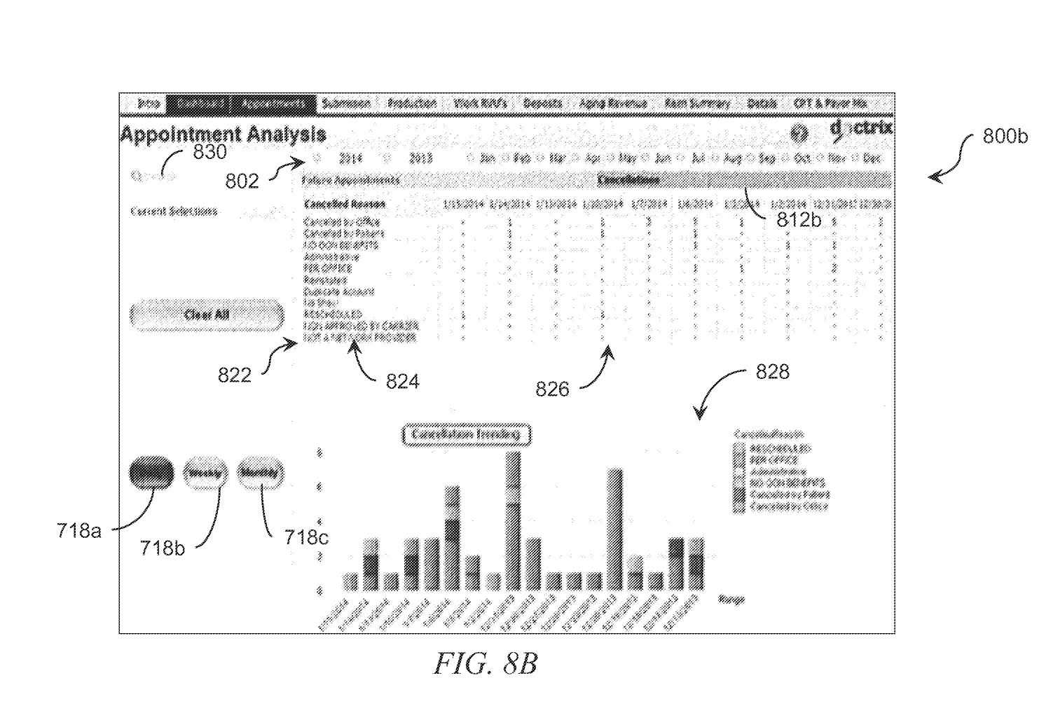

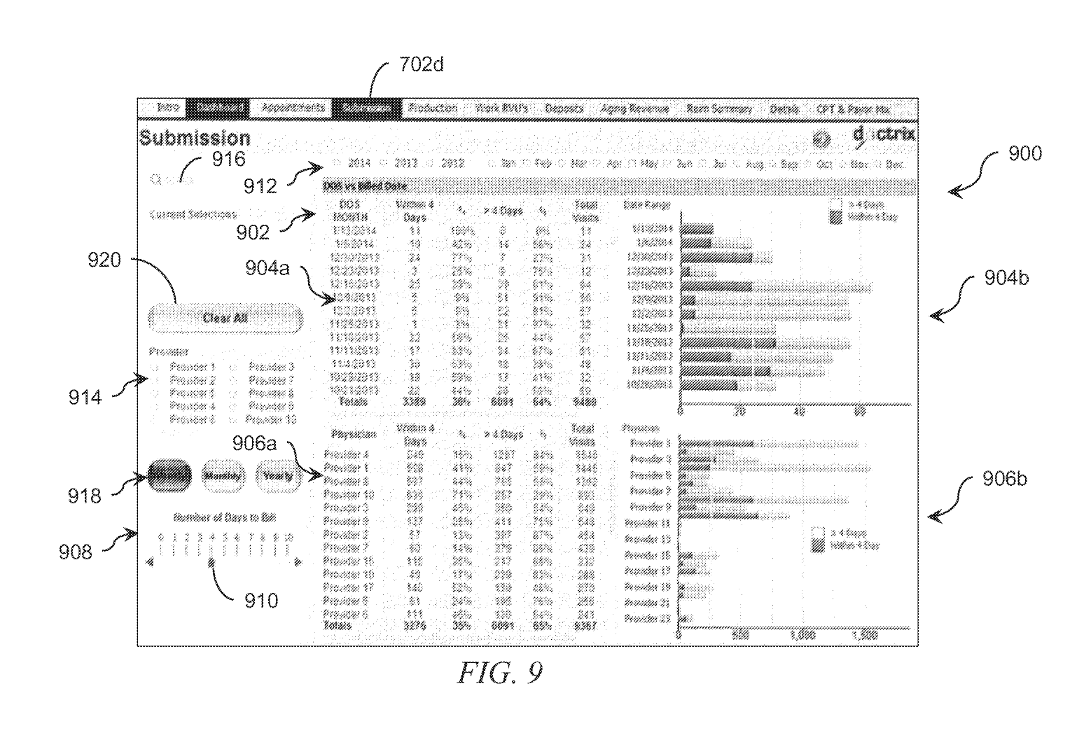

FIGS. 8A and 8B show the appointment management process facilitated on the dashboards. The dashboards are designed to provide the appointment management for RCM with the ability to project future cash flows whilst monitoring and maximizing recurrent patient trending. The raw medical services data captured in the appointments module of the practice management systems would capture detailed information pertaining to every patient appointment. This information would be converted to more insightful data and graphical view to be displayed on the application. The dashboards are mainly broken into the future appointments and the cancellations. However, it should be understood that this breakdown could vary significantly depending on the specialty and user requirements as understood in the art. The standard variants found in the key PMS are appointment type, physicians, and date parameters. The dashboard and appointments analysis tab and the sub tabs future appointments and cancellations all interact with one another. This interaction process is discussed in detail in FIG. 19. With regard to FIG. 8A, an appointment analysis interactive user interface to enable a user to analyze and manage appointment operations of a medical service provider is shown. The appointment analysis helps to provide for overall patient visit management, allow for a medical service provider identify current and future appointment trends and variances, drill down to facilitate root cause analysis on negative variances. The appointment analysis further helps a medical service provider project future cash flow through predictive analysis, including understanding recurring patient trends, determine growth/decline in appointment types, and streamline future expansions.

In response to a user selecting the appointments tab 702c, an appointment analysis interactive user interface 800a may be provided to the user. The user interface 800a may include time period selection elements 802 for filtering data to be displayed on the interactive user interface 800a. The time selection elements 802 may include selection elements 804a and 804b associated with year time periods 806a and 806b, where selection of both time periods 806a and 806b provides for comparisons between two successive years, in this case years 2013 and 2014. Additionally, selection elements 808a-808l may be associated with respective time periods 810a-810l for a user to select desired time periods (e.g., daily, weekly, monthly) to filter data to be displayed on the interactive user interface 800a.

Chart display screen 800a has data selections 802 with data buttons and data display, 804a, 804b, 806a, 806b, 808a, 808l, 810a and 810l. These button selections provide a month scale that the user is at privilege to select as and when required. If user wished to review the month of June all they need to do is select the June radio button. All data on the current tab as well as all other tabs would change within a few seconds to display only the selection criteria related data breakdown. This allows the user to select only 2014 or 2013 or any specific month or months. The dashboards tab and all other tabs will display details and the displayed data would change accordingly per their requirement.]

The appointment analysis interactive user interface 800a provides two tabs, including a future appointments tab 812a and cancellations tab 812b (collectively 812) for a user to view data associated with future appointments and appointment cancellations, respectively. The appointments analysis interactive user interface 800a allows for the medical service provider to improve charges per visit, better manage appointments, project future cash flows and expansions, and identify recurring patient trending.

Future appointments Tab 812 trending the upcoming appointments for a selected date range 814, 816, 818 which would be displayed based on the selection criteria chosen by the user at a given moment being either weekly 718a, monthly 718b, and yearly 718c or any other variant that maybe included such as appointment type, and physician. It should be noted that there could be various other sorting criteria that maybe required or included based on specialty needs. Whilst keeping a tab on future cash flows as a practice, a practice manager would also be able to monitor and maximize recurrent patient trending

In response to a user selecting the future appointments tab 812a, a table 814 showing a list of dates 816, in this case daily dates, and appointments 818 currently scheduled for each of the respective dates 816 may be displayed. It should be understood that the overall date range may be higher or lower, and that rather than showing daily dates, weekly or monthly date ranges may alternatively and/or additionally be displayed in response to a user selecting the weekly soft-button 718b and/or monthly soft-button 718c. In addition to the table 814, a graph 820, in this case a bar graph, may be displayed to show a graphical representation of the data being displayed in the table 814.

Upcoming appointments Chart 820 by day graph is a graphical representation of the future visits based on the selection criteria weekly 718a, monthly 718b, and yearly 718c or any other variant that maybe included such as appointment type, and physician. It should be noted that there could be various other sorting criteria that maybe required or included based on specialty needs. With these tabs user will be able to project the futuristic appointment trends. This helps the user to plan out their marketing campaigns and areas of focus. Whilst keeping a tab on future cash flows as a practice, a practice manager would also be able to monitor and maximize recurrent patient trending.

With regard to FIG. 8B, an appointment analysis interactive user interface 800b to enable a user to analyze and manage appointment operations of a medical service provider is shown. The appointment analysis interactive user interface 800b may be displayed in response to a user selecting the cancellations soft-button 812b. On the interactive user interface 800b, a table 822 may be shown that lists multiple cancellation reasons of patients 824 and numbers of cancellations 826 on a per date range basis associated with each of the cancellation reasons. By providing the table 822, a user may better determine how and why cancellations may be occurring so as to improve appointment management of the medical service provider, thereby helping to improve overall revenue of the medical service provider. For example, if it is determined that cancellations are high as a result of the medical service provider canceling (i.e., “Canceled by Office”), then processes may be improved so that fewer cancellations by the medical service provider may be implemented.

The appointment analysis Tab 702c generates a chart 828 using all appointment based information keyed into the PMS which was described in detail in FIG. 4 410. The raw medical services data relating to appointments management that was keyed into the PMS would have gone through a transformation process and converted to a secondary set of medical services data that would be finally output as integrated medical services data in these dashboard tabs. This appointment dashboard helps the user to analyze the appointment trends and notate the discrepancies and areas for improvement. You will be able to project the futuristic appointment trends, and understand the root causes for cancellations and no shows. This helps the user to plan out their marketing campaigns and areas of focus.

Cancellations trending Chart 828 is a graphical representation of the cancellations by reason based on the selection criteria weekly 718a, monthly 718b, and yearly 718c or any other variant that maybe included such as appointment type, and physician. It should be noted that there could be various other sorting criteria that may be required or included based on specialty needs.

To assist the user in identifying trends for patient cancellations, a chart 828, such as a bar chart, whereby each of the cancellation reasons may be tabulated and stacked on a per date range basis. It should be understood that alternative graphical representations may additionally and/or alternatively be utilized in accordance with the principles of the present invention. As with other interactive user interfaces, the user may filter the appointment cancellation data being displayed by selecting any of the time period soft-buttons 718, enter search term(s) into a search field 830, select a time period using the time selection elements 802, or otherwise.

The appointment analysis for cancelations allows for status-wise breakdown to better manage a practice appointment cycle that improves patient satisfaction. As with the appointments, the cancelation analysis provides for a “deep dive” into practice performance issues, facilitates timely corrective action, and improves administration efficiencies in (i) scheduling appointments, (ii) re-scheduling cancellations, and (iii) minimizing no-shows.

With regard to FIG. 9, a claims submission interactive user interface 900 is shown. Claims submission analysis provides for monitoring claims submission against industry benchmarks. Such benchmarks may provide for time taken to bill from date of service and the ability to compare physician efficiencies for claim submission timelines. Moreover, the claims submission analysis allows for determining root causes for delays of claims submissions to enable a medical service provider to take timely corrective action, thus speeding up the payment collection period of the revenue cycle.

The interactive user interface 900 may enable the medical service provided to reduce delays in billing out claims, track and monitor claims, and relate claims submission of the medical practice to industry benchmarks. A number of interactive reporting regions 902 include a date of service (DOS) versus billed date data table 904a, a chart 904b showing a graphical representation of the data presented in table 904a, physician versus billed data table 906a, and chart 906b provides a graphical representation of the data included in the table 906a. The data table 904a may include weekly or other time period records associated with dates of service, where each of the records in the table 906a includes a date, number of claims submitted within a selected number of days (e.g., 4 days), percentage of the number of claims submitted within a selected number of days with respect to total number of patient visits, number of claims submitted over a selected number of days after a visit, percentage of claims submitted over a selected number of days, and total visits of patients. It should be understood that the configuration of the tables 904a and 906a and charts 904b and 906b are illustrative and that alternative configurations may be utilized in accordance with the principles of the present invention.

In FIG. 9, the submissions Tab 702d generates the submission display page 900 that allows claims related to secondary level integrated medical services to be submitted with data capture and conversion from a PMS 324a or 324n. The claims submission 900 could be tracked from date of service, billed date, or similar data parameters tracked in the PMS 324a or 324n. The claims submission and recommended days to bill timelines could vary at a specialty level. That is, a surgery related claim would have a longer turnaround time as opposed to an audiology related claim. The invention allows to billing date from service to be adjusted. This dashboard display 900 helps to streamline the differentiators and benchmark the practice's operational effectiveness in billing out these claims. It provides the ability to track claims and reduce time delays during claims submission. The following sections outline the detailed sections of the dashboard submission display 900. Any selections made on this display 900 would also interact and provide outputs taking into account the selection on other pages and tab selections.

Date of service (DOS) versus Billed date Column 902 and 904a reflects the delay in billing out the claims through the system to the actual date of service on which the patient was seen. This Column 902 and 904a would display based on the selection made weekly, monthly or yearly 918. Another aspect of Column 902 and 904a that would influence the data that is displayed would be the selection made on the scroll bar at the far left bottom of the dashboard 900 using the pointer 910 currently set at ‘4’. The benchmark number of days to bill that these claims are currently being analyzed is billing out the claims 4 days from DOS.

Bar chart 904b is the graphical representation of the data displayed based on the current selections made on viewing time frame 918 or number of days to bill scroll bar 908, 910. It would portray the data currently being analyzed on DOS vs. billed sub Tab 902 on the submission dashboard.

Data chart 906a reflects the submissions traceable based on provider 914. This again would display based on the selection made weekly, monthly or yearly 918. Another aspect that would influence the data that is displayed would be the selection made on the scroll bar at the far left bottom of the dashboard 908 using the pointer 910 currently set at ‘4’. The benchmark number of days to bill that these claims are currently being analyzed is billing out the claims 4 days from DOS.

Bar chart 906b is the graphical representation of the data displayed based on the current selections made on provider or similar variant 914. Bar chart 906b portrays the data currently being analyzed on physician sub-Tab 906a on the submission dashboard.

A graphical user element 908, such as a slider, enables a user to select a number of days to bill or otherwise submit claims for reimbursement to the medical service provider. As shown, graphical user selection element 910 may enable a user to interactively select and slide the number of days to bill to be higher or lower than four days. If the selection element 910 is increased or decreased, the claims submission data in the tables 904a and 906a and charts 904b and 906b may be automatically adjusted based on the selected number of days to submit claims by the user. Filter parameters, such as date range selection elements 912, provider selection elements 914, search entry field 916, time range soft-buttons 918, or otherwise, may be utilized to filter data being presented in the interactive user interface 900. To present all of the data that is currently available for claims submissions, the user may select a “clear all” soft-button 920, as previously described herein.

A scroll bar 908 facilitates the selection process to enable a benchmarking mechanism within the application. The number of days to bill indicates a target benchmark that would be ideal to be achieved. Immediately the DOS vs. Billed date 902 table would indicate the number and percentage of visits exceeding this target value. It would also display based on whatever selection criteria selected at that given moment.

Pointer 910 on the scroll bar 908 indicates the current benchmark figure selected to indicate the ideal ‘number of days to bill’. This pointer 910 would work in alignment with the scroll bar 908.

Year selection Tab 912 is a year, month scale that the user selects when required. If user wished to review the month of June, all they need to do is select the June radio button Tab 912 should be selected. All data on the current Tab 912 as well as all other tabs would change within a few seconds to display only the selection criteria related data breakdown. This allows the user to select only 2014 or 2013 or any specific month or months for the row tabs 912. The dashboards tab and all other tabs will display details and the displayed data would change accordingly per their requirement.

The user radio button 914 can review a given physician at a given instance and claims related to only that physician. If for example, the reviewer wished to understand the status on the claims submitted by physician 3, they could select physician 3. The particular selection would then be listed under the current selections section immediately, whilst simultaneously the user interface submission dashboards would change values accordingly. The search bar 916 is available for the user to make any preferential searches at any given time. The weekly, monthly or yearly selection criteria 918 is available to the user. Column DOS month in the DOS vs. Billed date 902 tab would be outlined per the selection made here.

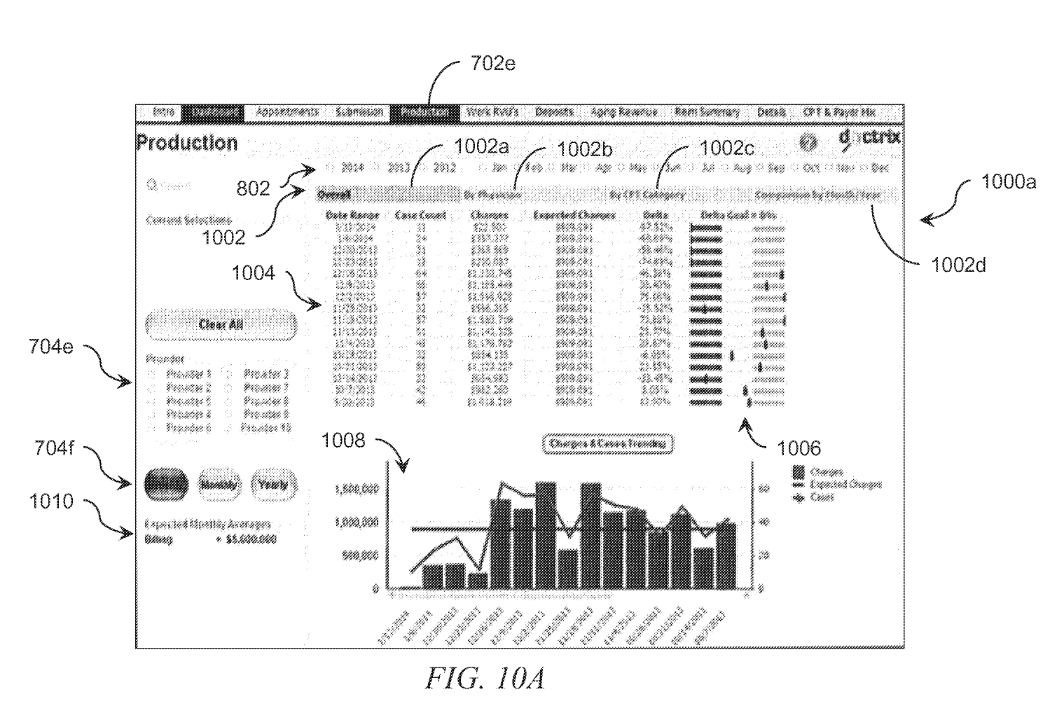

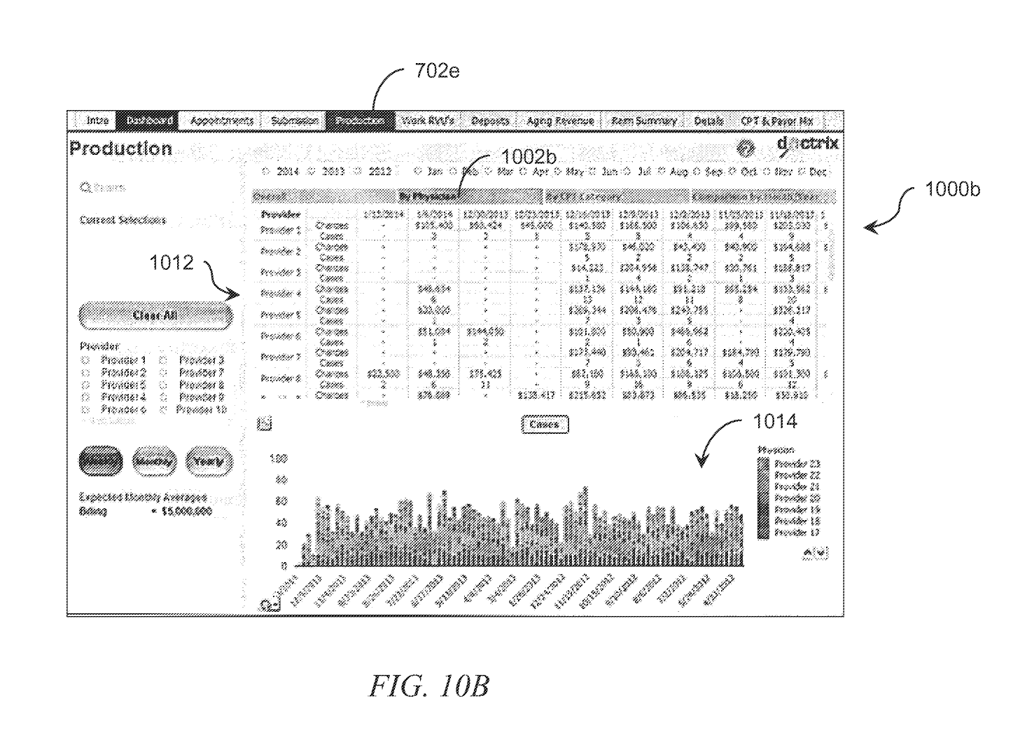

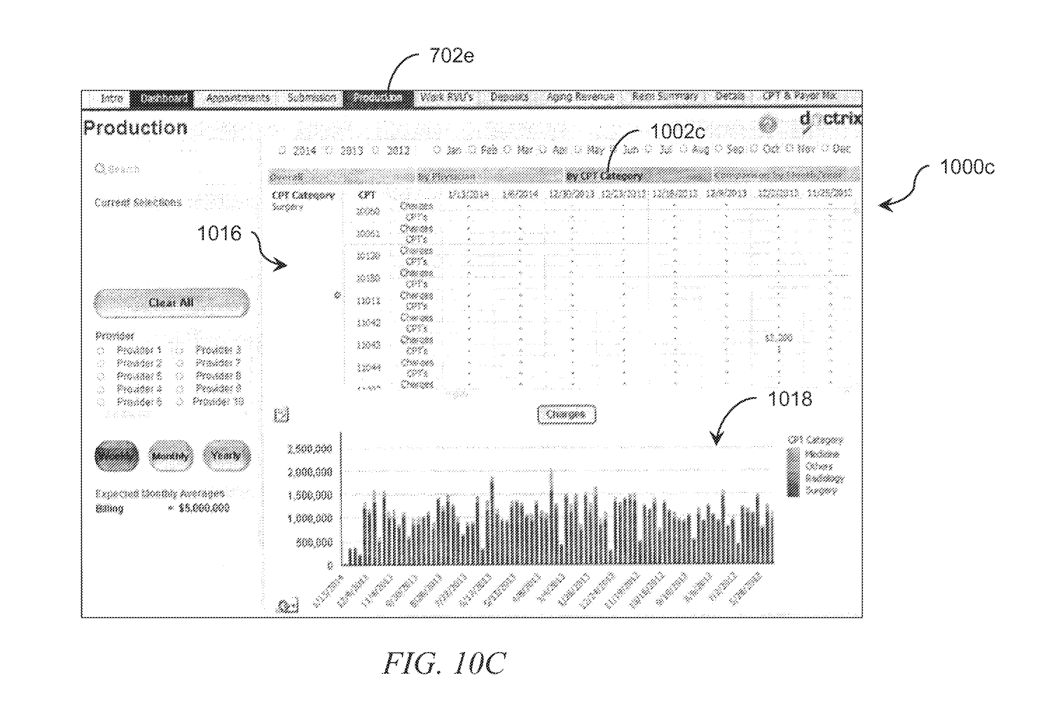

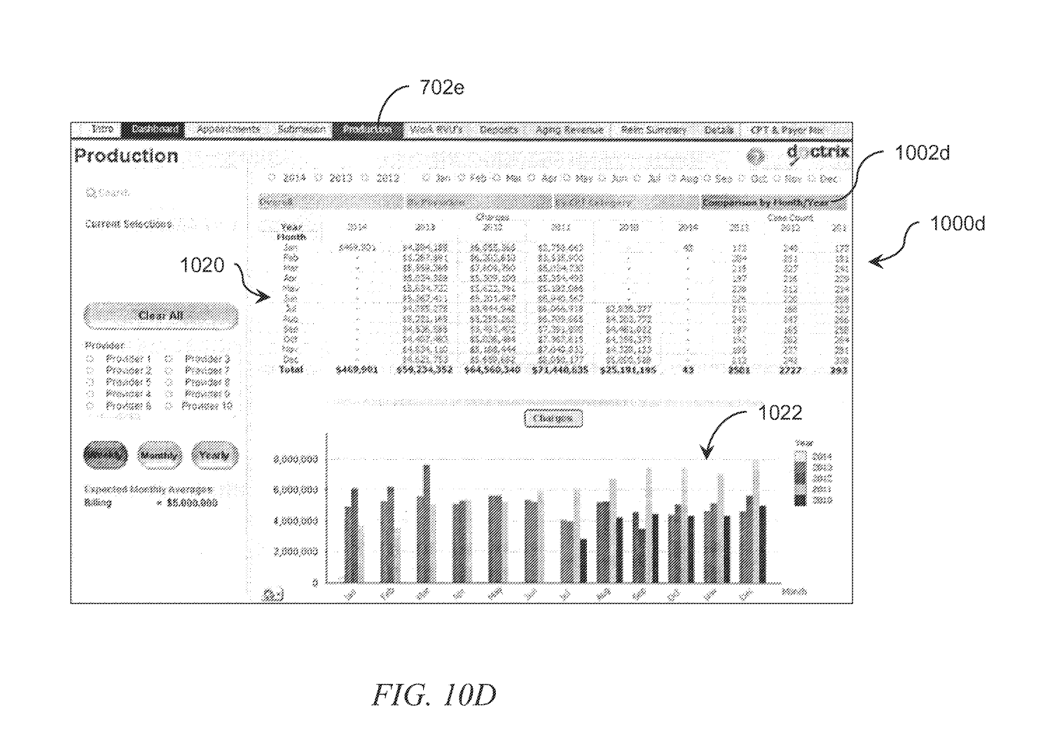

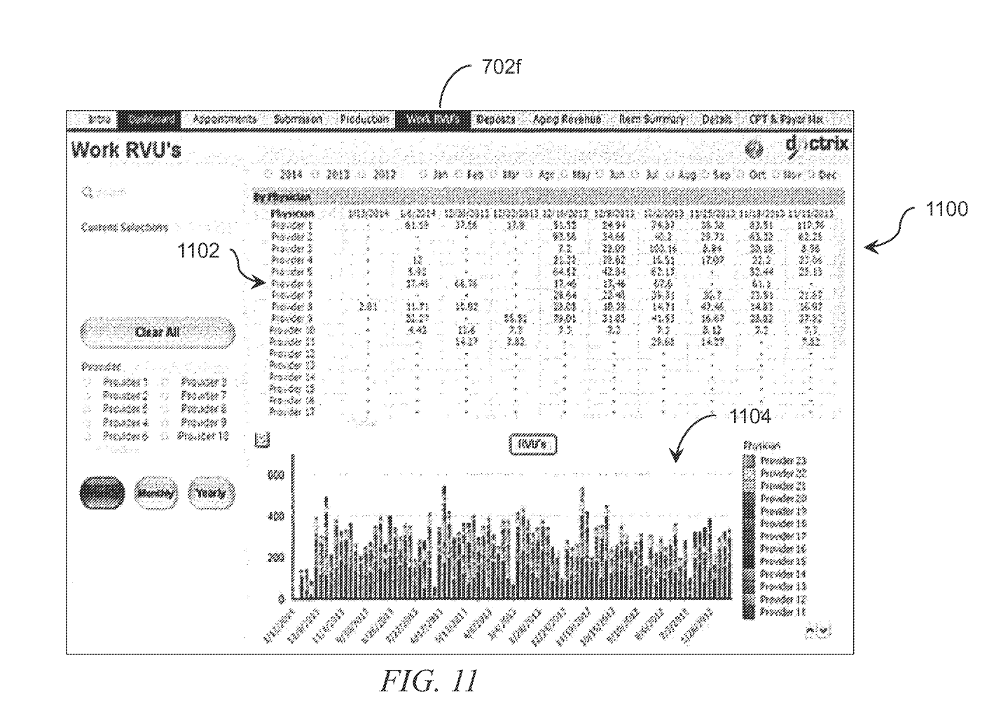

Production dashboard screens 1000a-1000d on FIGS. 10A-10D are generated by production Tab 702e. FIG. 10A shows overall production screen 1002a, FIG. 10B shows production by physician 1002b, FIG. 10C shows production by CPT category 1000c, and FIG. 10D shows production comparison by month/year 1000d.

With regard to FIG. 10A, a production dashboard 1000a showing overall production of a medical services provider is shown. The production dashboard 1000a may provide for a user to monitor revenue and projections of revenue by having the ability to monitor visits versus claims, which ultimately provides the ability to improve average payment per visit for a medical service provider. The production dashboard may assist a medical service provider in (i) determining overall view of a total claims value and claims count, (ii) performing variance analysis against expected charges and patient visit count, and (iii) understanding claims details of problem areas to identify root causes of problems with production of a medical service provider.

The user may access the production dashboard 1000a by selecting the production tab 702e. As shown in the production dashboard 1000a, tabs 1002 may enable the user to select an “overall” tab 1002a, “by physician” tab 1002b, “by CPT category” tab 1002c, and “comparison by month last year” tab 1002d. The “overall” tab 1002 may cause table 1004 to be displayed. The table 1004 may include data that is representative of overall production to enable the user to see production trends over time. In one embodiment, records in the table 1004 may be date dependent over a time period, such as weekly. The table 1004 may include various production data, such as case count, charges, expected charges, and delta between the charges and expected charges. In addition, each data record in the data table 1004 may have an associated graphic, such as a bar along with an indicator of actual production relative to desired or expected charges, as shown. The use of colors, such as red, yellow, and green, may be used to indicate good/bad weekly production. Below the table 1004 is shown an illustrative chart 1008 that includes charges, expected charges, and number of cases in a single chart to provide the user with the graphical representation of the data in the table 1004.

As with other dashboards, the production dashboard 1000a may include filter section 704e that allows a user to select one or more provider, section 704f that allows a user to select time period, and time period selection elements 802. In one embodiment, data 1010 of desired and/or average production, such as expected monthly averages, may be displayed.

On FIG. 10A, timeframe scale 802 is available for the user is at privilege to select as and when required. If user wished to review the month of June, the June radio button on row 802 should be selected. All data on the current tab as well as all other tabs would change within a few seconds to display only the selection criteria related data breakdown. This allows the user to select only year 2014, year 2013, or any specific month or months. The dashboards tab and all other tabs will display details and the displayed data would change accordingly per their requirement.

Dashboard provider selection area 704e selects a specific physician (or similar criteria) for analysis. Select a particular physician on area 704e, and the associated values, tables and graphs pertaining to same will change in a manner of seconds. The dashboard and all other tabs would refresh to the current selection and help the user to proceed further with their analysis.

Selection Tab 704f allows the user to select between the periodic elements they wish to analyze the dashboards based on. The dashboard and all other tabs would refresh to the current selection in a manner of seconds and help the user to proceed further with their analysis.

Expected monthly average summary 1010 for billing is displayed in a separate section for monitoring and review purposes to help the user.

Overall production or charges on claims charts 1004 detail in this area, including date range column that displays based on the current selection made on weekly, monthly or yearly selection Tab 704f. The case counts would reflect the visits and applicable cumulative charges for the date range selected. The expected charges would also be displayed based on a 3 or 6 month moving average trending. The variance between actual and expected charges would be displayed as delta, and delta goal 1006 would indicate if this variance was positive (green), negative (red) or neutral (yellow). With regard to FIG. 10B, a production dashboard 1000b showing production by physician in a multi-physician organization is shown. The dashboard 1000b provides provider-level claims performance monitoring for a user that may help a user understand provider efficiencies. The multi-physician organization may be a hospital, clinic, or any other organization in which multiple physicians provide medical services. The dashboard 1000b is displayed responsive to a user selecting tab 1000b. Table 1012 may be displayed according to provider (e.g., Provider 1-Provider 9) and include both charges and number of cases being handled by each of the respective providers. The charges and cases may be shown over time (e.g., each week or each month) so that trends in amount of production or number of cases may be determined by the user. As further shown, a chart 1014 may show case and/or production data of the table 1012 in a visual manner to assist a user to visually determine trends. In effect, by being able to view provider efficiencies and/or inefficiencies, practice production performance may be improved for each of the providers. In addition, potential revenue opportunities or shortfalls may be flagged by the user by having access to provider-level production.

The charges and cases trending graph 1008 is a graphical representation of the production sub detail tab being viewed. Physician Column 1002b on FIG. 10B allows the reviewer or user of the dashboards to analyze and review any major variance in the production values for a given period based on the values displayed on the overall tab 1002a that they could drill down further to investigate. They would be able to review the physician level production details on tab 1002b. This Tab 1002b would also reflect figures based on the current selection. It would highlight any under producing provider and user could involve in a self-exploratory analysis of same. Graph 1014 shows a graphical view of production by physician as displayed based on the current selection measures.

With regard to FIG. 10C, a production dashboard 1000c showing production by current procedural terminology (CPT) category is shown. The dashboard 1000c may be used to identify potential revenue by services rendered and specialty procedures along with short payments by CPT. In response to a user selecting the tab 1002c, a table 1016 that provides CPT categories and associated charges and number of CTPs. Below the table 1016 may be a chart that provides for charges on a time period basis. As with other dashboards, filtering functionality is available for the user to be able to investigate whatever timeframe, provider, year, month, or other filtered parameter(s) desired by the user.

Tab 1002c on FIG. 10C allows a physician or user to access related information to analyze the production per CPT category 1016. Charges and visits per CPT category could be investigated further for review. Graphical view 1018 on FIG. 10C shows production by CPT category and would be displayed based on the current selection measures.

With regard to FIG. 10D, a production dashboard 1000d showing production comparison by month/year is shown. The dashboard 1000d may be used to provide cumulative period-on-period comparison of total claim charges and patient visits. Additionally, the dashboard 1000d provides a user with the ability to view claim-level details to investigate deviations to enhance positives and to eradicate negatives in a timely manner. A table 1020 provides for a year-over-year comparison of production (columns 2-6) and case counts (columns 7-10). It should be understood that the time periods for comparison may be different. As shown, filtering using the various filter functionality also may be applied to data being presented in the table 1020. Also shown is a graph 1022 that presents comparison data of production charges generated by a medical service provider in a multi-year visual format, in this case a bar graph.

Comparison Tab 1002d on FIG. 10D allows a user to review and compare the month/year values 1020, which would be displayed in a user friendly format for self-exploration. The graphical view of production comparison by month/year 1022 would be displayed based on the current selection measures.

With regard to FIG. 11, a dashboard 1100 that presents work relative value units (RVUs) for providers (e.g., physicians) is provided. The dashboard 1100 enables a user to monitor provider efficiencies, improve provider time utilization, and understand physician profiles and clinical performance. The dashboard 1100 may include a table 1102 that includes a list of providers that shows RVUs to compare providers on a time period basis (e.g., weekly). A chart 1104 may show columns that stack the RVUs of providers to provide the user with a visual inspection of overall production of the collective providers. As with the other dashboards, filtering using the various filter functionality previously presented may also be applied to data being presented in the table 1102 and chart 1104.

Tab work RVUs 702f generates related dashboards and RVU screen 1100 to improve provider time utilization, monitoring provider efficiencies and understanding physician profiles and clinical performance. The work RVU screen 1100 provides graphical benchmark scales that help graphically illustrate the provider or physician's performance based on specialty type.

Outlines Column table 1102 provides physician performance indexes based on selected criteria. Weekly, monthly or yearly values would display based on selection. Graphical table 1204 provides the graphical representation of the work RVU related information.

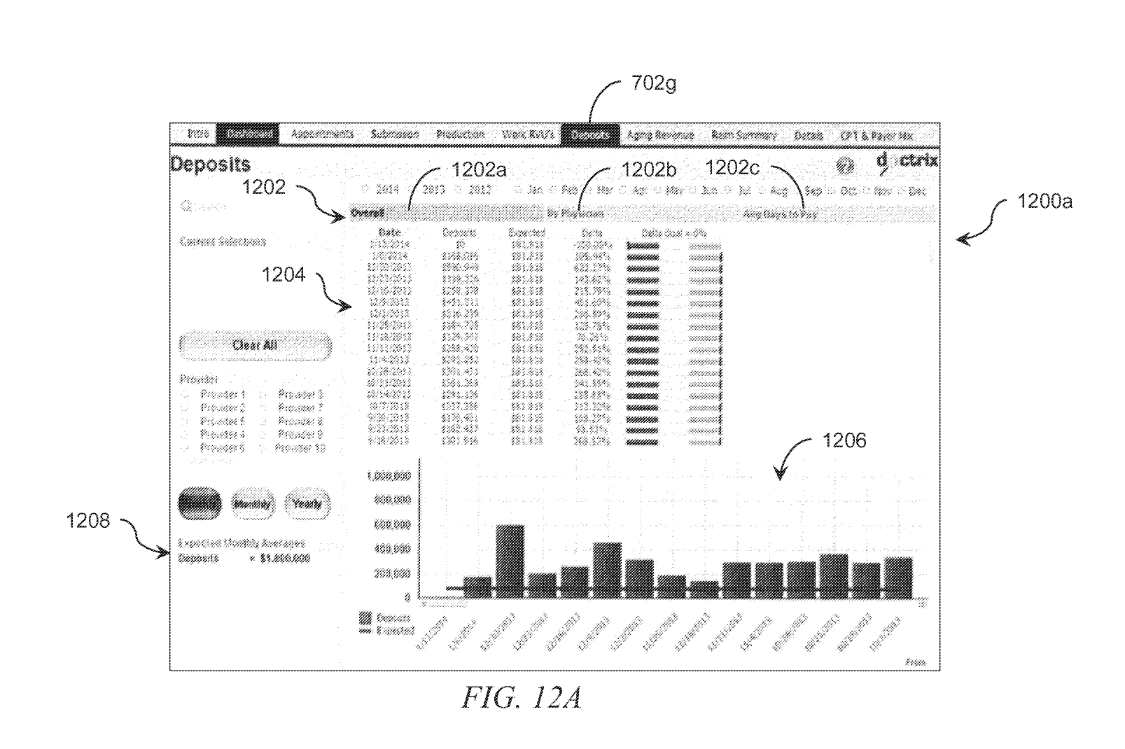

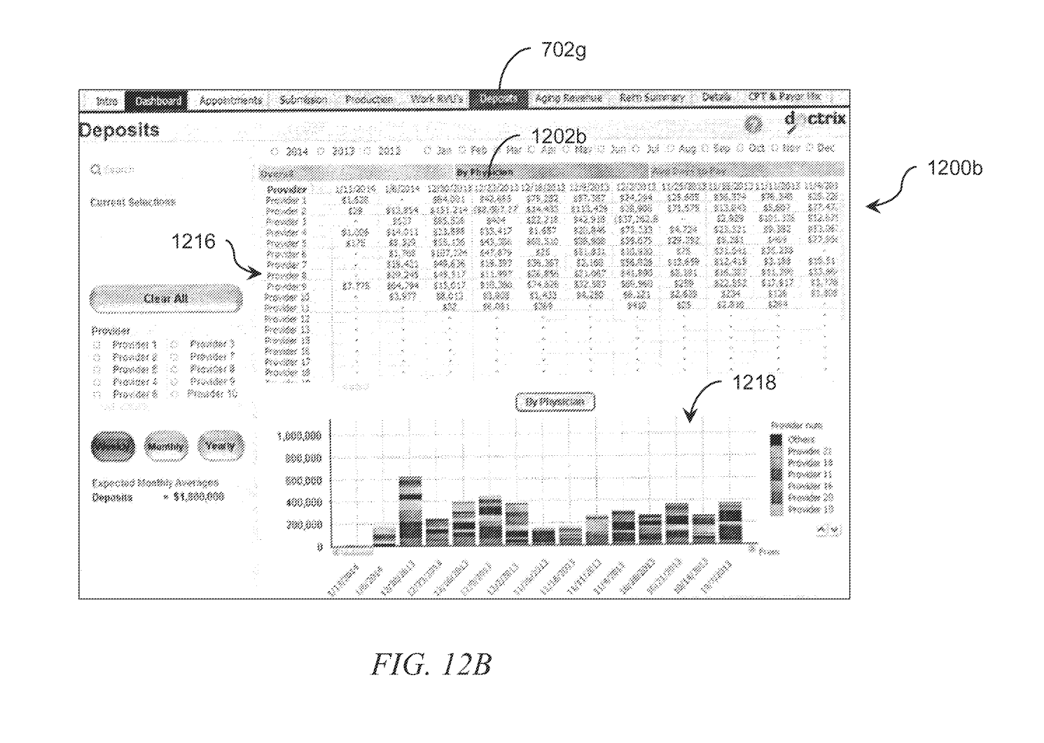

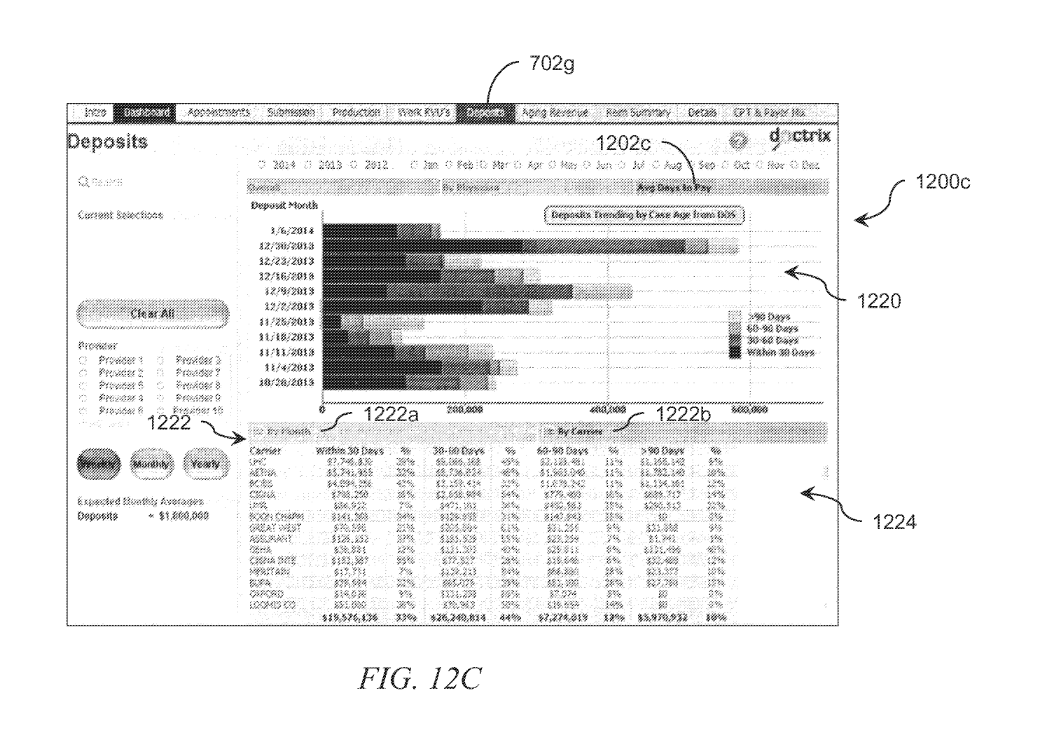

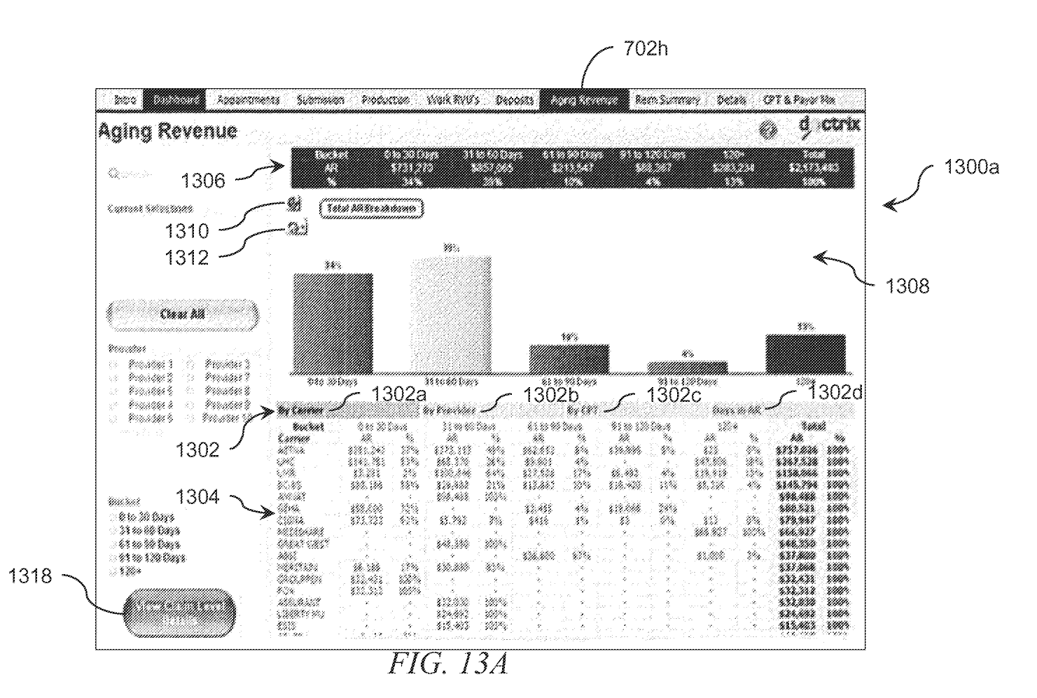

Tab deposits 702g generates information using the dashboard screen shots that assist a medical service provider to manage and analyze deposits by the practice. As shown in FIG. 12A-12C, screens 1200a, 1200b and 1200c show the deposit related information in table and graph forms. FIG. 12A displays the deposits overall on screen 1200a, FIG. 12B displays the deposits by physician on screen 1200b, and FIG. 12C reflects the deposits average days to pay information on screen 1200c. The displayed information can vary based on specialty needs and selected criteria.

With regard to FIG. 12A, a deposits dashboard 1200a that presents deposits received by a medical service provider is shown. The deposits dashboard 1200a provides a medical service provider with the ability to monitor and projected cash flow, track payment sources, and monitor insurance versus patient payment. Additionally, a user of the dashboard 1200a may be provided with the ability to monitor and improve financial health of a medical practice. The dashboard 1200a may include a set of tabs 1202, including an “overall” tab 1202a, “By Physician” tab 1202b, and “Avg Days to Pay” tab 1202c. Additional and/or alternative tabs may also be provided.

The overall deposits Tab 1202 in FIG. 12A on screen 1200a provides dates based on the current select weekly, monthly or yearly. This deposits review shows the actual deposits against the expected calculation based on the moving average to understand the current variance. Graph 1206 shows that the graph of overall deposits outlines dates based on the current select weekly, monthly or yearly, would then be graphically reflected in the bar chart below.

A table 1204 may include a date, deposits associated with that date, expected deposits, delta between deposits and expected deposits, and graphical elements, such as a line-bar to show a graphical representation of the delta. A graph, such as a bar graph, may be presented to display deposits along with an expected amount of deposits. The dashboard 1200a may further enable a user to enter expected monthly average deposits in a data field in region 1208. As with other dashboards, using the various filter functionality may also be applied to data being presented in the table 1204 and chart 1206. The data presented in the table 1204 and chart 1206 may highlight expected versus actual deposits for a given time period to ensure that services rendered are paid for sufficiently. From this deposits information, long term survival of the medical practice or provider may be monitored.

The Physician Tab 1202b in FIG. 12B on screen 1200b shows deposits for physician or providers, which conduct analysis on the provider level with a specified breakdown of any other selected criteria. The deposits graph 1218 by physician details would be reflected per the current selection criteria in a graphical representation view for the ease of use for the user.

With regard to FIG. 12B, a deposits dashboard 1200b that presents deposits on a provider basis is shown. The dashboard 1200b may enable a user to monitor deposits received by a physician, examine claim-level details to understand specifics of deposits, and take appropriate corrective action to improve physician-level financial health. The dashboard 1200b may be displayed in response to a user selecting tab 1202b. A table 1216 may list providers along with deposits made for each provider over time periods. A chart 1218 may also show a graphical representation of the values in the table 1216 in a format, such as a bar chart, that shows total collections by the providers. As with the other dashboards, filtering using the various filter functionality previously presented may also be applied to deposit data being presented in the table 1216 and chart 1218.

The average day to pay 1202c tab in FIG. 12C on screen 1200c provides a representation of the average days to pay by month 1222a and by carrier 1222b. The bar chart 1220 shows deposits trending by case age from DOS, in a graphical representation, which helps identify the deposits received based on the aging of claims.

With regard to FIG. 12C, a deposits dashboard 1200c that presents deposits based on average days to pay is shown. By presenting the deposits based on average days to pay, a user may monitor claims payments received from the date billed to improve the days to pay, understand insurance carrier timeframe for payment, and understand first-time claim fixes. A graph or chart 1220 may display deposits over time periods, such as weekly, monthly, or yearly bases. Tabs 1222 may enable a user to select to view deposit data in a table 1224 by month (tab 1222a) or by carrier (tab 1222b). The table 1224, as shown, is displaying the deposit data by carrier. It should be understood that alternative and/or additional tabs that enable the user to selectively view the deposit data in any format may be provided. As with the other dashboards, filtering using the various filter functionality previously presented may also be applied to deposit data being presented in the table 1224 and chart 1220.

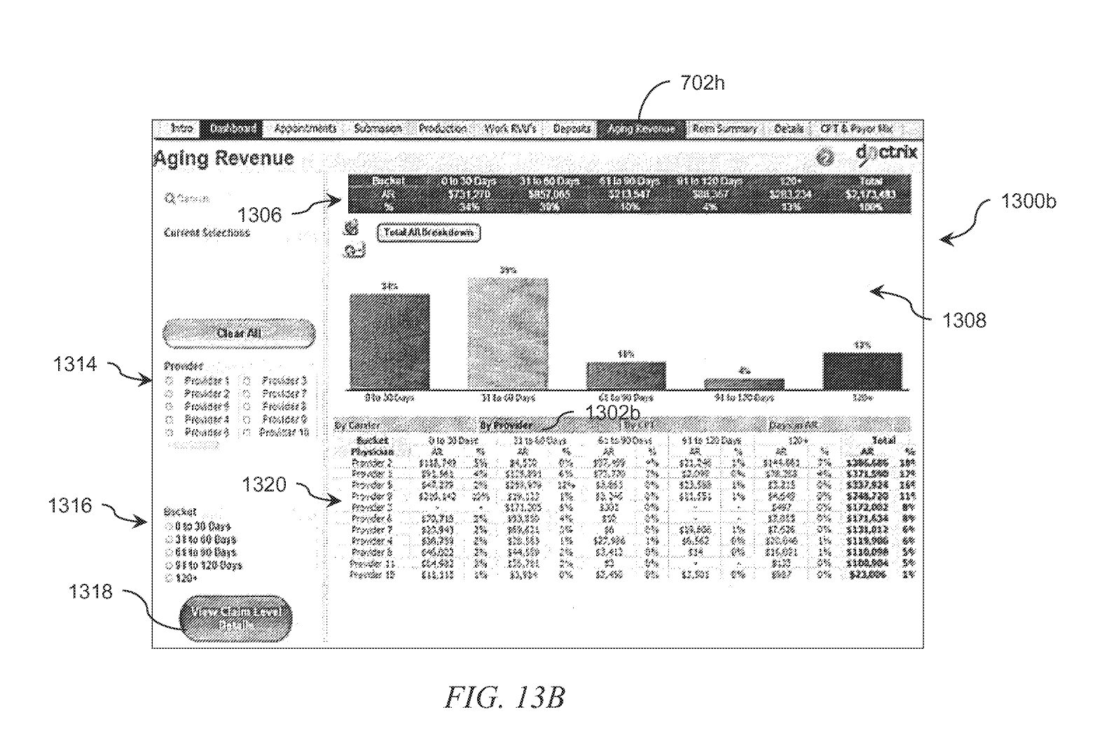

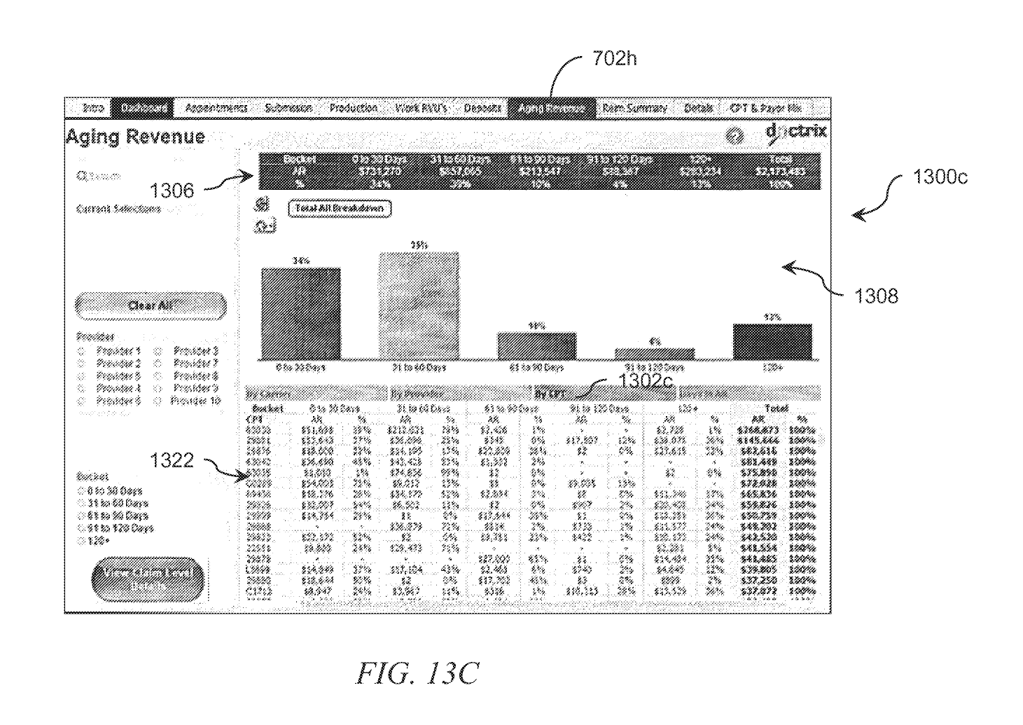

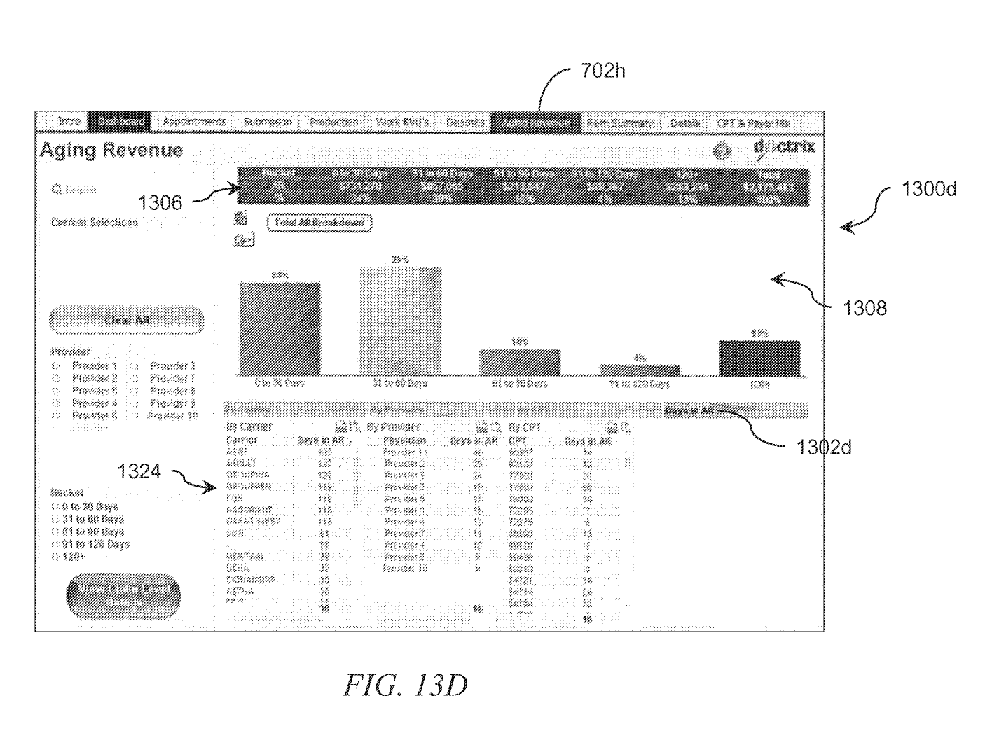

Aging revenue screens 1300a-1300d in FIG. 13A-13D enable a medical service provider to monitor aging revenue of a medical practice. Aging Revenue Tab 702h generates charts and tables that provide an integrated medical services data analysis available for evidence based aging revenue analysis. FIG. 13A displays aging by carrier on screen 1300a, FIG. 13B displays aging by provider on screen 1300b, FIG. 13C displays aging by CPT on screen 1300c, and FIG. 13D displays aging by days in AR on screen 1300d. The viability of a medical practice is determined by its ability to collect cash on claims billed and the ability to collect cash fast, and hence, analysis of aging revenue is an important calculation in the industry. Known systems and reports fail to allow and capture the evidence based analysis on same, which the current invention remedies by manipulated data.

With regard to FIG. 13A, an aging revenue dashboard 1300a that enables a medical service provider to monitor aging revenue is shown. The aging revenue dashboard 1300a may provide for evidence-based claims reimbursement monitoring, include collection processes and collected revenue, allow for a user to investigate non-payments and short payments, and determine reasons for delays of payment by providing access to detailed claims-level revenue information.

The dashboard 1300a is shown to include selectable tabs 1302, including a “by carrier” tab 1302a, “by provider” tab 1302b, “by CPT” 1302c, and “days in AR” tab 1302d. The selectable tabs 1302 enable a user to view aging accounts receivable revenue data in a table 1304 by selecting one of the selectable tab categories (e.g., by carrier). The table 1304 enables a user to monitor accounts receivable by carrier, project future service delivery based on predictive trending to maximize practice performance, and ensure maximum cash is collected from each insurance carrier.

Display Tab 1306 shows the overall aging revenue to be collected from the outstanding claims, and button 1310 allows the user to switch to the preferred graph view by clicking between a pie chart to a bar chart format or vice versa. Tab 1312 allows the user to switch from values ($) to % or vice versa.

Aging by carrier row 1302a on row 1302 of screen 1300a of FIG. 13A generates an outline that clearly sets forth the highest contributors from a payer perspective who contribute to majority of the aging. The analysis of the carrier payment patterns helps user streamline a diagnostic, predictive and prescriptive evidence based analysis of the aging revenue.

In addition to the table 1300a for presenting aging revenue in a detailed manner based on selectable categories (e.g., by carrier), an accounts receivable summary table 1306 shows aging revenue of accounts receivable in different successive time frames (e.g., 0 to 30 days, 31 to 60 days, 61 to 90 days, 91 to 120 days, 120+ days, and total AR). The summary table 1306 provides the user with a high-level listing of aging revenue of the medical service provider. A chart 1308 shows a graphical representation of the accounts receivable data in the accounts receivable summary table 1306. Graphical user element 1310 may enable the user to select a different chart format to view the accounts receivable data in the accounts receivable summary table 1306. Graphical user element 1312 may enable a user to switch between accounts receivable dollars versus percentage of accounts receivable being displayed in the chart 1308. It should be understood that alternative and/or additional tabs that enable the user to selectively view the deposit data in any format may be provided. As with the other dashboards, filtering using the various filter functionality previously presented may also be applied to aging revenue data being presented in the tables 1304 and 1306 and chart 1308.

Aging by provider Tab 1302b on row 1302 of screen 1300b of FIG. 13B generates an outline of the highest contributors to the aging by provider. The analysis of the carrier payment patterns helps user streamline a diagnostic, predictive and prescriptive evidence based analysis of the aging revenue. With regard to FIG. 13B, an aging revenue dashboard 1300b that may be utilized to monitor aging revenue of each provider being monitored is shown. The dashboard 1300b enables a user to determine specific reasons for unpaid or rejected claims by cross-examining across provider-level performance of accounts receivables. The dashboard 1300 may further enable the user to ensure accurate and timely claim payments. In response to the user selecting the “by provider” tab 1302b, table 1320 may be displayed that lists each provider in a left-hand column, for example, along with accounts receivable for successive time periods. As with the other dashboards, filtering using the various filter functionality previously presented may also be applied to aging revenue data being presented in the table 1320.

The aging by CPT Tab 1302c on row 1302 of screen of screen 1300c of FIG. 13C generates a review of the highest paid and lowest paid CPTs. The analysis of the carrier payment patterns helps user streamline a diagnostic, predictive and prescriptive evidence based analysis of the aging revenue. With regard to FIG. 13C, an aging revenue dashboard 1300c that enables a user to monitor accounts receivable by CPT codes is shown. The dashboard 1300c allows a user (i) to access details of CPT's or services rendered to provide for decisions on projected growth, (ii) to ensure existing claim payments are accurate, (iii) to investigate into non-payments or short payments and determine reasons for such, and (iv) to take corrective action to rectify aging revenue situations. In response to the user selecting the “by CPT” tab 1302c, table 1322 may be displayed. The table 1322 may display CPT codes in a left-hand column, for example, and associated accounts receivable by successive time periods. As shown, the table 1322 is sorted from highest to lowest total accounts receivable of the CPT codes. As with the other dashboards, filtering using the various filter functionality previously presented may also be applied to aging revenue data being presented in the table 1322.

The aging by days in AR Tab 1302d on row 1302 of screen 1300d of FIG. 13D generates another key criterion that helps the user understand the current buckets potential in terms of future collections. The analysis of the carrier payment patterns helps user streamline a diagnostic, predictive and prescriptive evidence based analysis of the aging revenue. With regard to FIG. 13D, an aging revenue dashboard 1300D that enables a medical service provider to monitor duration taken for claims to be paid is shown. The dashboard 1300d enables a user to determine reasons or causes for delays in payments and to take corrective action to improve the financial health of the medical service provider. In response to a user selecting the “days and AR” tab 1302d, table 1324 may be displayed. The table 1324 may include each of the carriers, providers, and CPT codes along with total number of days in AR of each of the respective carriers, providers, and CPT codes. In one embodiment, the table 1324 may be sorted by one or more of the carrier, provider, and CPT code columns. Alternatively or additionally, the table 1324 may be sorted by days in AR (e.g., highest number of days in AR to lowest number of days in AR). As with the other dashboards, filtering using the various filter functionality previously presented may also be applied to aging revenue data being presented in the table 1324.

Tab 1318 on screen 1300a-1300d of FIGS. 13A-13D provide a reflection of the figures in the dashboards and tabs based on the variables integrated to enable the evidence based analysis of the aging revenue, which can change per the healthcare specialty and other factors. In this particular instance the generic criterion being provider, CPT and days in AR are the key criteria selected by the user. These criteria could vary depending on specialty based requirements as selected by the user. Whatever the criteria selected, the display graphics and charts are displayed in the current selections area. If at any given time user wished to conduct an in-depth analysis by the claim level details, the program allows such in-depth analysis by a click on Tab 1318 to ‘view claim details’ and the information would be displayed.

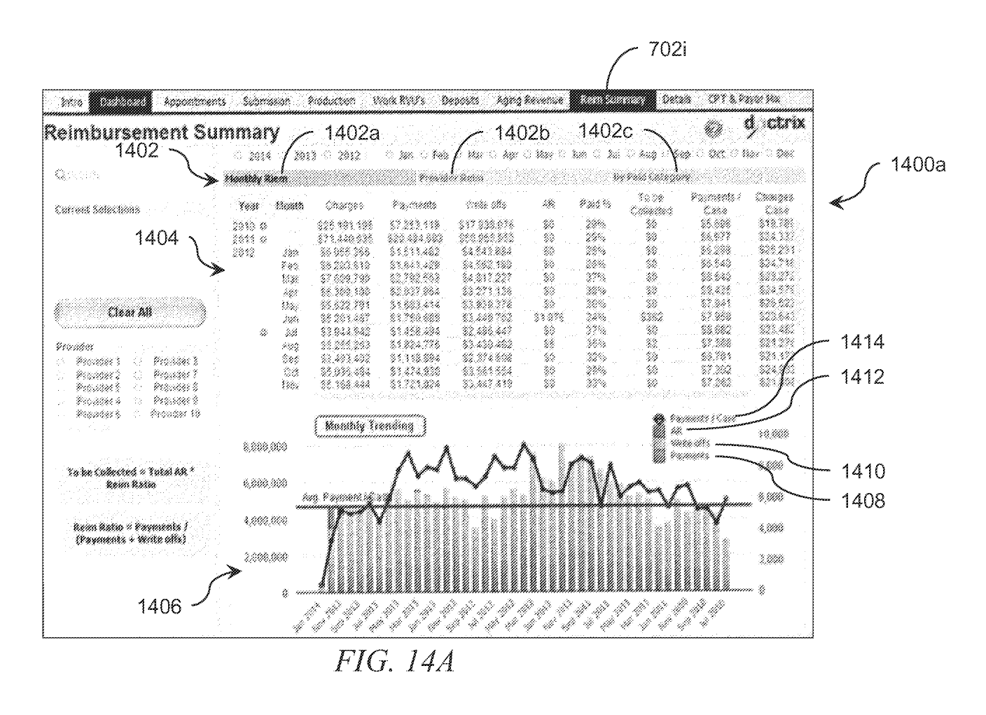

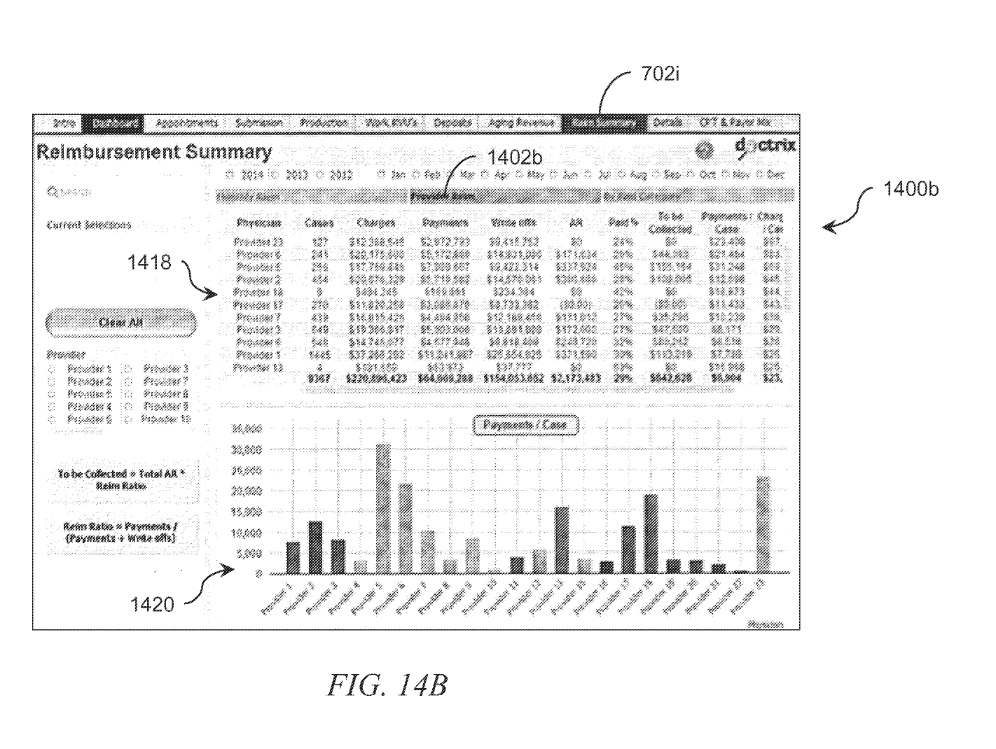

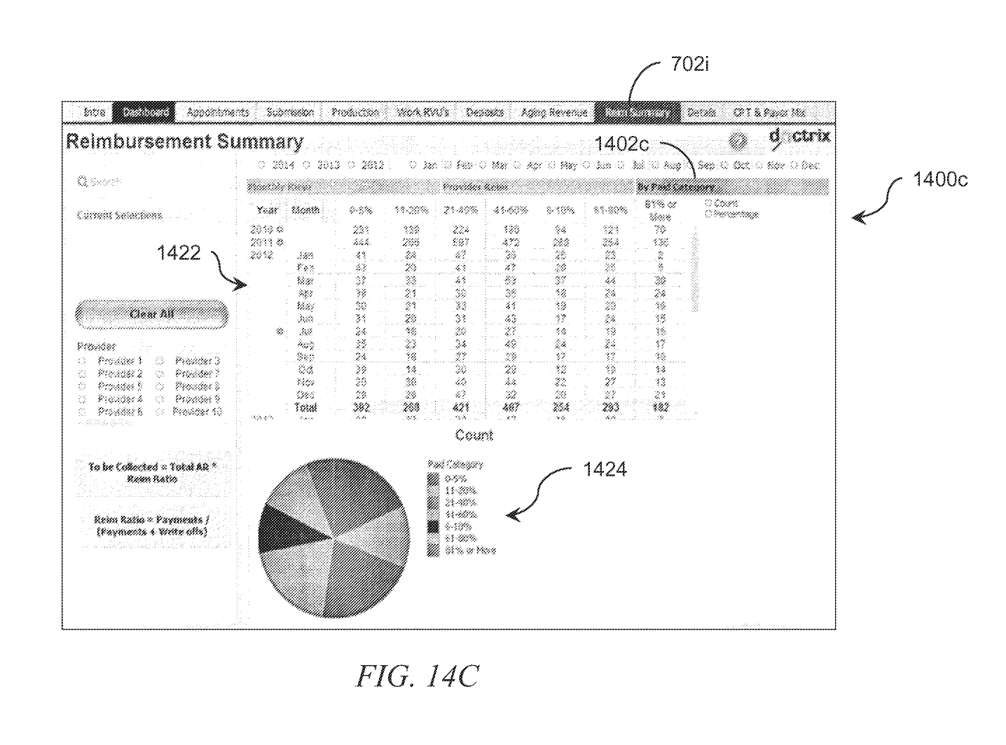

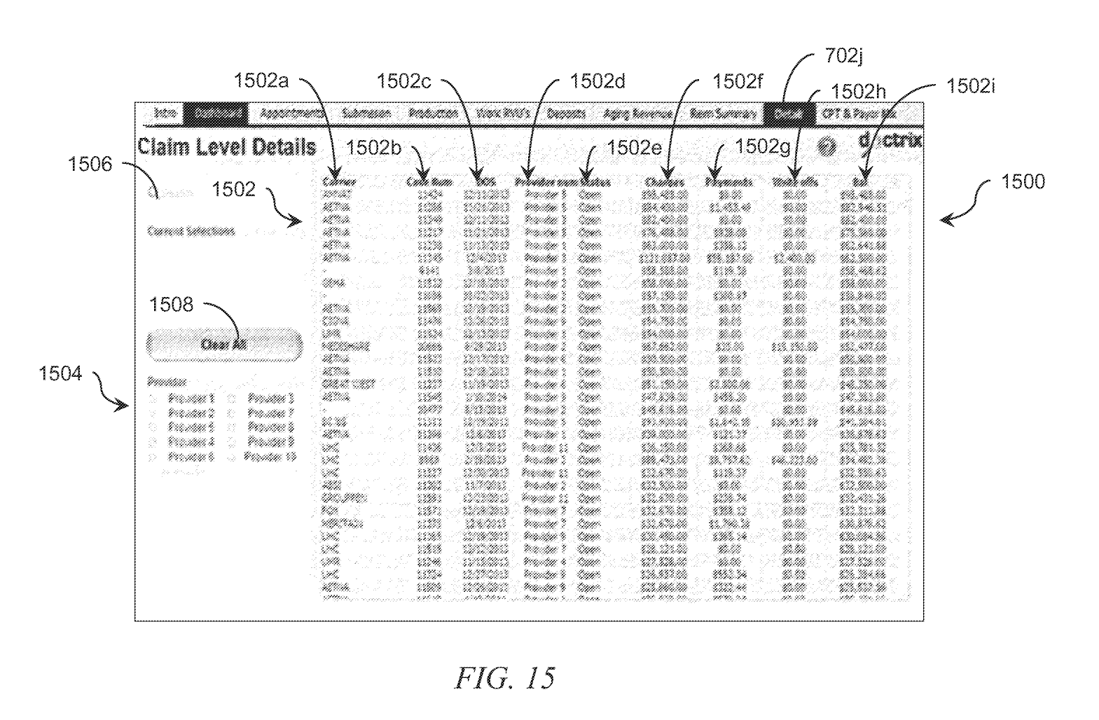

The reimbursement summary Tab 702i generates summary screens 1400a-1400c on FIGS. 14A-14C that track reimbursements for a medical service provider. These screens 1400a-1400c track revenue, monitor accuracy of claim fee schedule payments and keep tabs on uncollected or short non payments on claims. Evidence based reimbursement monitoring is also boosted to assist a practice and its operational effectiveness, which are the process outlined based on the current invention in FIG. 14A-FIG. 14C. Screen 1400a on FIG. 14A outlines the Monthly reimbursements, screen 1400b on FIG. 14B displays the provider reimbursements, and screen 1400c on FIG. 14C displays the reimbursements by paid category. The potential of a practice is determined by its ability to get reimbursed on the higher majority of billed claims. The systems and reports in the prior art failed to allow and capture the evidence based analysis on same, while the present invention allows the manipulation of data sufficiently to be able to help with this drawback to a greater level.

With regard to FIG. 14A, a reimbursement summary dashboard 1400a that tracks reimbursements for a medical service provider is shown. In addition, the dashboard 1400a enables a medical service provider to track opportunities to increase revenue, monitor accuracy of cleaning fee schedule payments, and keep track of uncollected, short, or lost payments. Moreover, the dashboard 1400a enables a user to maximize claims collections and monitor percentage of payments as a component of actual payments and contractual write-offs.

The dashboard 1400a may include selectable tabs 1402 that enable a user to select “monthly reimbursements” tab 1402a, “provider reimbursements” tab 1402b, and “by paid category” tab 1402c. In response to a user selecting the monthly reimbursements tab 1402a, a table 1404 may be displayed that includes year, month, charges, payments, write-offs, AR, percentage to be collected, payments per case, and charges per case parameters. It should be understood that alternative and/or additional parameters may be included in the table 1404. As understood in the medical service community, write-offs are very typical as a result of insurance companies having contractual payments with medical service providers for each task or procedure performed by the medical service provider. As a result, it is typical that medical service providers receive less than 50% of their hourly rates. Hence, every available dollar available collected is important for a medical service practice to maintain a viable medical practice.

The monthly reimbursements outline 1402a on row 1402 of FIG. 14A shows month on month charges, payments and write offs comparison alongside any accounts receivable amounts, payments per case and charges per case. Tab 1402a generates the paid % or reimbursement ratio and the ‘to be collected’ value. Graph 1406 shows the data selected in 1402a at any given instance.

A chart 1406 may be used to graphically display data that is presented in the table 1404. The chart 1406 may display payments 1408, write-offs 1410, accounts receivable 1412, and payments per case 1414 in a manner that assists the medical service provider in maximizing claims collections. As with the other dashboards, filtering using the various filter functionality previously presented may also be applied to reimbursement summary data being presented in the table 1404 and chart 1406.

With regard to FIG. 14B, a reimbursement summary dashboard 1403 that allows the medical service provider to monitor reimbursements by provider is shown. To access the dashboard 1400b, a user may select the “provider reimbursement” tab 1402b to cause table 1418 to be displayed. The table 1418 may display physician identifiers on the left-hand column along with cases, charges, payments, white offs, AR, paid percentage to be collected, payments per case, and charges per case parameters. It should be understood that alternative and/or additional parameters may be included in the table 1418. The table 1418 may be sorted by any of the parameters provided therein to enable the user to view the data in any desired order he or she may want. Chart 1420 may display payments per case may provide a graphical representation for the user to compare each of the providers so as to determine which providers are performing higher value cases. The chart 1420 may be presented in any chart format and may include any of the data of table 1418 desired by the user. As with the other dashboards, filtering using the various filter functionality previously presented may also be applied to reimbursement summary data being presented in the table 1418 and chart 1420.

Tab 1402b on screen 1400b on FIG. 14B shows Provider level reimbursements and outlines the reimbursements on the month on month charges, shown payments and write offs comparison alongside any accounts receivable amounts, payments per case and charges per case. It calculates the paid % or reimbursement ratio and the ‘to be collected’ value. Graph 1420 shows the data selected in 1402b at an given instance. That is the provider based payments per case.

With regard to FIG. 14C, a reimbursement summary dashboard 1400c that enables a medical service provider to analyze highest paying claims of a medical practice is shown. The dashboard 1400c may be displayed in response to a user selecting the “by paid category” tab 1402c. In response to the user selecting the tab 1402c, table 1422 may be displayed. The table 1422 may list year, month, and successive percentage ranges (e.g., 0%-5%, 6%-10%, 11%-20%) to show number of claim reimbursements in each of the successive percentage ranges for the medical service provider. A chart 1424 may be presented to show a graphical representation of reimbursement percentages provided by data in the table 1422. As with the other dashboards, filtering using the various filter functionality previously presented may also be applied to reimbursement summary data being presented in the table 1422 and chart 1424.

Paid Category Tab 1402c on screen 1400c on FIG. 14C shows the applicable information for the reimbursements by paid category analysis. That is the paid % or the reimbursement ratio is categorized into ranges and reviewed further. Graph 1424 shows the data selected in 1402c at any given instance. That is the provider based count of claims per paid category.

FIG. 15 is a screenshot of an illustrative details dashboard that provides claim-level details for a medical service provider. The detailed claim level details are always prevalent based on any current selection criteria that maybe selected by user during their self-exploratory analysis process. With regard to FIG. 15, a claim-level details dashboard 1500 that provides claim-level details for a medical service provider is shown. The details dashboard 1500 enables the medical service provider to view any detailed listing for all claims for any current selection (i.e., filtered data). By being able to view claim-level details, a user may be able to identify root causes for negative situations that may be occurring in a medical practice. Similarly, a user may be able to identify positive situations and understand how and why certain operations and financials of the medical practice are positively occurring.

The claim-level details dashboard 1500 may be displayed in response to a user selecting the “Details” tab 702j while viewing another dashboard (e.g., “Dashboard” (FIG. 7), “Production->Overall” (FIG. 10A), “Production->By Physician” (FIG. 10B), “Production->By CPT Category” (FIG. 10C), and “Production->Comparison by Month/Year” (FIG. 10D)). The details dashboard 1500 allows for the user to view specific practice performance using diverse variables to discover practice potential or underlying variances. Moreover, as a result of providing the claim-level detail tab, the user is able to view any claim-level details related to overall operations and production within three or four clicks.

The claim-level details may be displayed in a table 1502 that includes data records 1502a-1502n (collectively 1502). The claim level details may include a number of parameters, including carrier 1502a, case number 1502b, date of service (DOS) 1502c, provider number 1502d, status 1502e, charges 1502f, payments 1502g, write-offs 1502h, balance 1502i, and any other parameters that may be utilized by a medical service provider in managing a medical practice. As with the other dashboards, filtering using the various filter functionality previously presented may also be applied to claim-level detail data being presented in the table 1502. For example, the user may be provided with a selectable list of providers 1504 and search field 1506 to filter the claim-level detail data. To reset or unfilter the claim-level details dashboard 1500, the user may select a “Clear All” soft-button 1508.

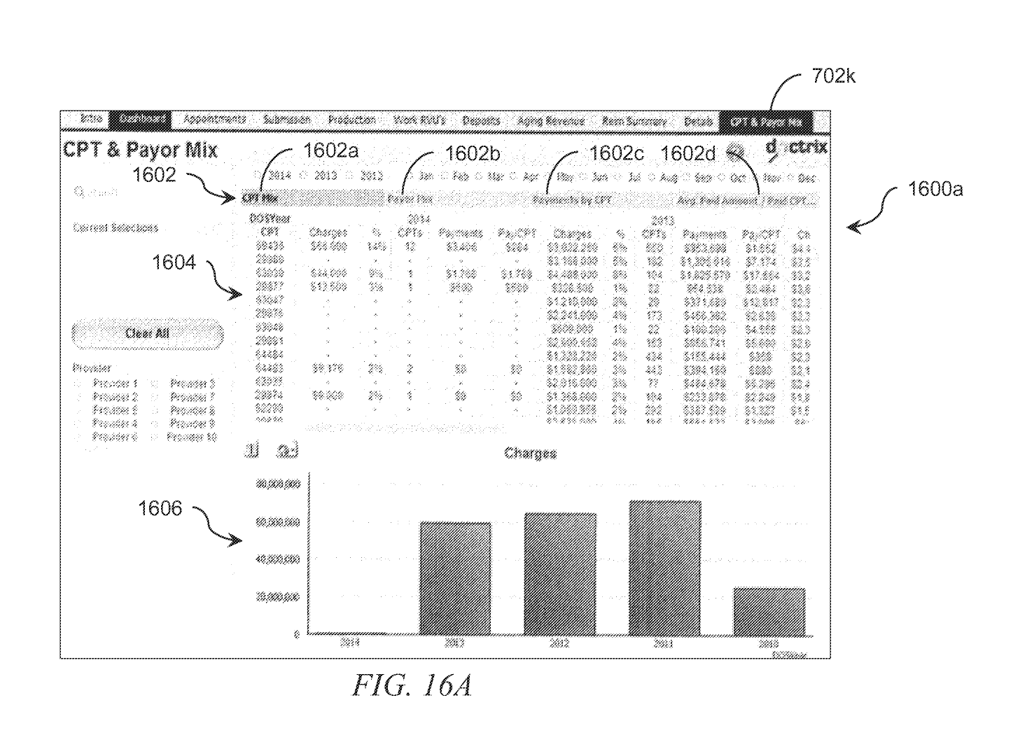

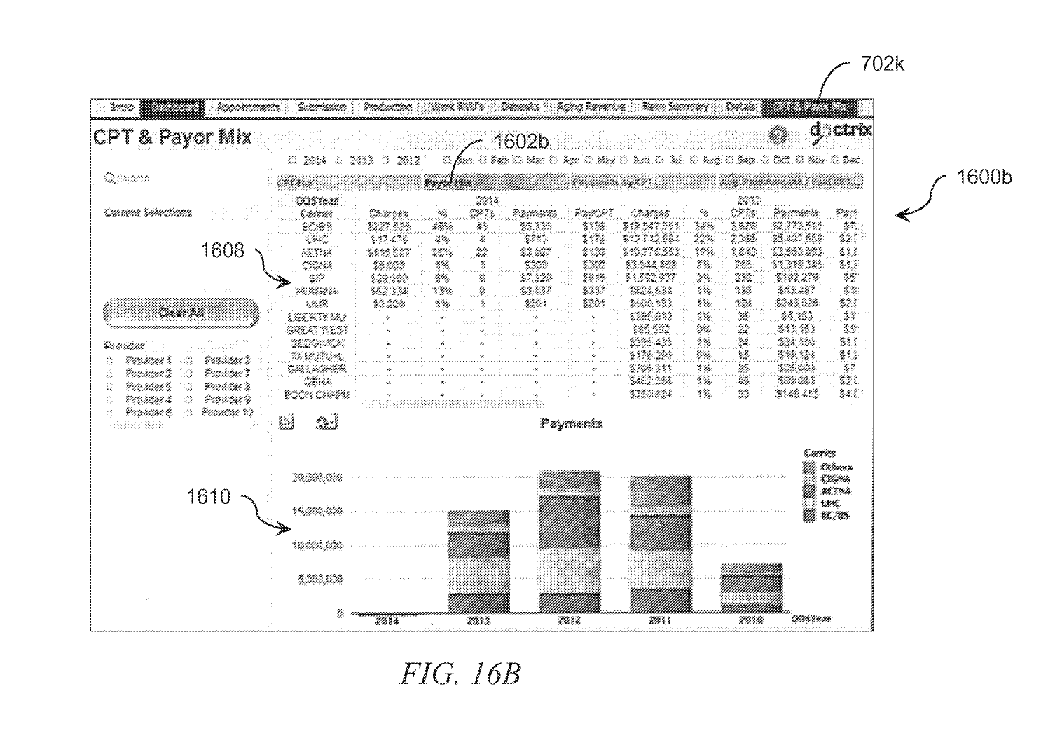

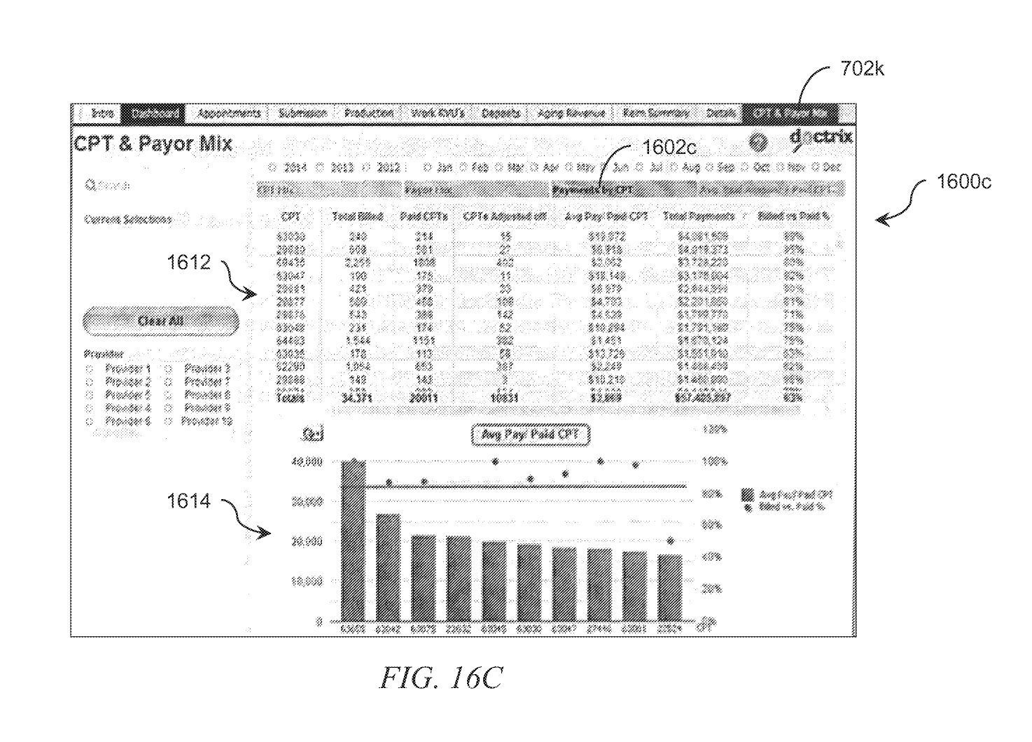

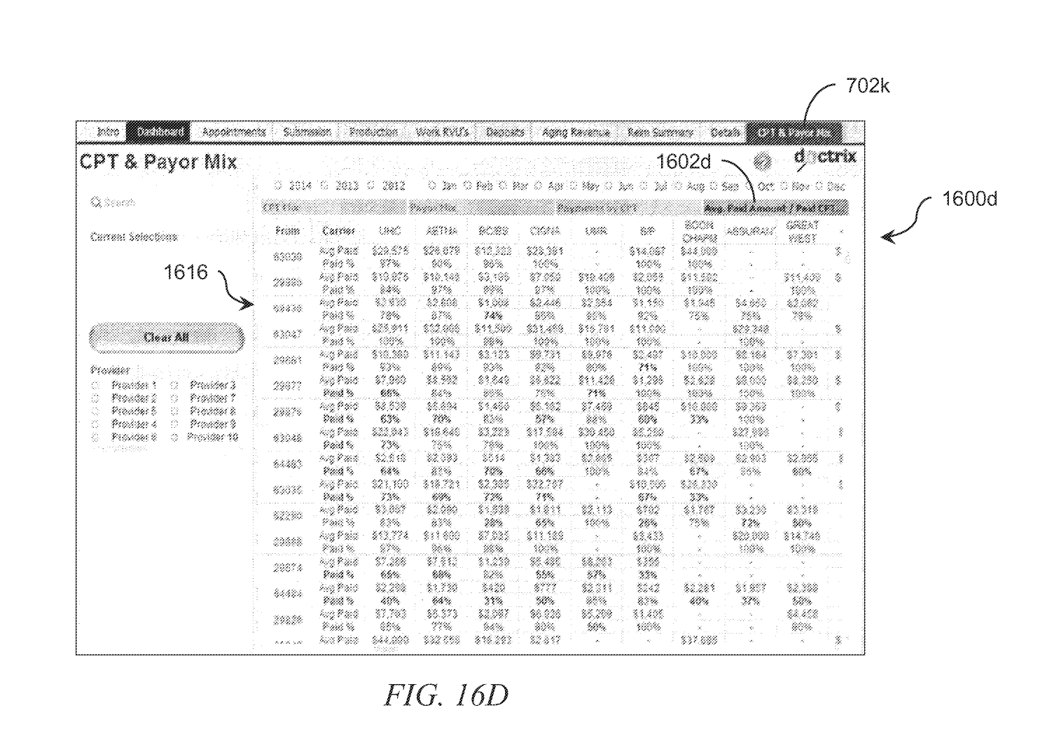

FIGS. 16A-16D are screenshots of illustrative CPT & payer mix dashboards that enable a medical service provider to access and view payments on a CPT and payer basis. The CPT, payer mix Tab 702k details are the other key performance measures to deep dive into the root cause for a positive or negative surge in the practices performance or operational effectiveness or revenue increase or such occurrence. FIG. 16A-16D depicts the process that would strengthen the evidence based aging and reimbursements and claims tracking process. Tab 1602a displays the CPT mix. That is the outline of the top paying CPTs. Tab 1602b displays the Payer mix. That is the outline of the top paying payers. Tab 1602c displays the payments by CPT. This shows the totaled billed count of CPTs and the number of CPTs that paid, CPTS adjusted off, avg. pay/paid CPT, total payments for individual CPTs. Tab 1602d displays the average paid amount/paid CPT.

With regard to FIG. 16A, a CPT & payer mix dashboard 1600a is shown. The dashboard 1600a enables the medical service provider to monitor highest-paid procedures, track carrier payment strategies, monitor procedural reimbursements, and ensure maximum and accurate payment for medical services. The dashboard 1600a may be used to guide a medical service provider with expansion plans by determining highest paid or reimbursed procedures. By the medical service provider being able to identify payment strategies of carriers, the medical service provider may be able to adjust its medical practice and services being offered and prescribed to align itself with higher reimbursement rates by carriers.

As shown, the dashboard 1600a includes a number of different selectable tabs 1602 that, in response to a user selecting one of the tabs 1602, causes data associated with those tabs to be displayed. The tabs 1602 may include a “CPT mix” tab 1602a, “payer mix” tab 1602b, “payments by CPT” tab 1602c, and “average paid amount per paid CPT” tab 1602d. Each of these tabs 1602 are CPT centric, and it should be understood that additional and/or alternative tabs may be available in accordance with the present invention.

In response to the user selecting the tab 1602a, table 1604 may be displayed. Table 1604 may include a number of different parameters, including date of service year, CPT, percentage of CPT charges as compared to all charges for that time period, number of CPTs, payments, and payments received per CPT. It should be understood that additional and/or alternative time periods (e.g., date of service by month) and parameters for the CPT mix table 1604 may be presented in accordance with the principles of the present invention. Moreover, the table 1604 may be sorted by any parameter (i.e., data in each column), such as charges, to enable the user to display the data in any format or order that he or she chooses.

Also shown is a chart 1606 that shows historical charges, in this case year-over-year. It should be understood that the format of the chart 1606 may be any other chart format (e.g., pie chart), as understood in the art. As with the other dashboards, filtering using the various filter functionality previously presented may also be applied to CPT mix data being presented in the table 1604 and chart 1606.

With regard to FIG. 16B, a CPT & payer mix dashboard 1600b is shown. This dashboard 1600b allows for a medical service provider to monitor periodic carrier-level procedural reimbursements. In response to a user selecting the “payer mix” tab 1602b, table 1608 may be presented. Table 1608 may include a number of different parameters, including date of service year, carrier, charge percentage of charges for each carrier, number of CPTs, and payments received from each carrier. It should be understood that additional and/or alternative time periods (e.g., date of service by month) and parameters for the payer mix table 1608 may be presented in accordance with the principles of the present invention. Moreover, table 1608 may be sorted by any parameter (i.e., data in each column), such as total billed, to enable the user to display the data in any format or order that he or she chooses.

Also shown is a chart 1610 that shows historical payments, in this case year-over-year payments, by carriers. It should be understood that the format of the chart 1610 may be any other chart format (e.g., pie chart), as understood in the art. As with the other dashboards, filtering using the various filter functionality previously presented may also be applied to payer data being presented in the table 1608 and chart 1610.

With regard to FIG. 16C, a CPT & payer mix dashboard 1600c is shown. This dashboard 1600c allows for a medical service provider to monitor procedural reimbursements for accuracy and capture billing errors. In response to a user selecting the “payments by CPT” tab 1602c, table 1612 may be presented. Table 1612 may include a number of different parameters, including CPT, total number of CPTs billed, total number of CPTs paid, number of CPTs adjusted off, average payment per paid CPT, total payments, and billed versus paid percentage. It should be understood that additional and/or alternative parameters for the payments by CPT table 1612 may be presented in accordance with the principles of the present invention. Moreover, table 1612 may be sorted by any parameter (i.e., data in each column), such as charges, to enable the user to display the data in any format or order that he or she chooses.

Also shown is a chart 1614 that shows average payment per paid CPT. It should be understood that the format of the chart 1614 may be any other chart format (e.g., line graph), as understood in the art. As with the other dashboards, filtering using the various filter functionality previously presented may also be applied to payments by CPT data being presented in the table 1612 and chart 1614.

With regard to FIG. 16D, a CPT & payer mix dashboard 1600d is shown. This dashboard 1600d enables a medical service provider to understand competitiveness of payer contracts, identify underpayments, ensure maximum and accurate payment, and improve practice performance. In response to a user selecting the “average paid amount per paid CPT” tab 1602d, table 1616 may be presented. Table 1616 may include a number of different parameters, including carriers along each column and average paid CPT and CPT paid percentage along each row to produce a matrix that can easily be visually scanned by a user. It should be understood that additional and/or alternative parameters for the payments by table 1616 may be presented in accordance with the principles of the present invention. Moreover, table 1616 may be sorted by any parameter, to enable the user to display the data in any format or order that he or she chooses. Although no chart is presented in dashboard 1600d, it should be understood that a chart may also be utilized in accordance with the principles of the present invention.

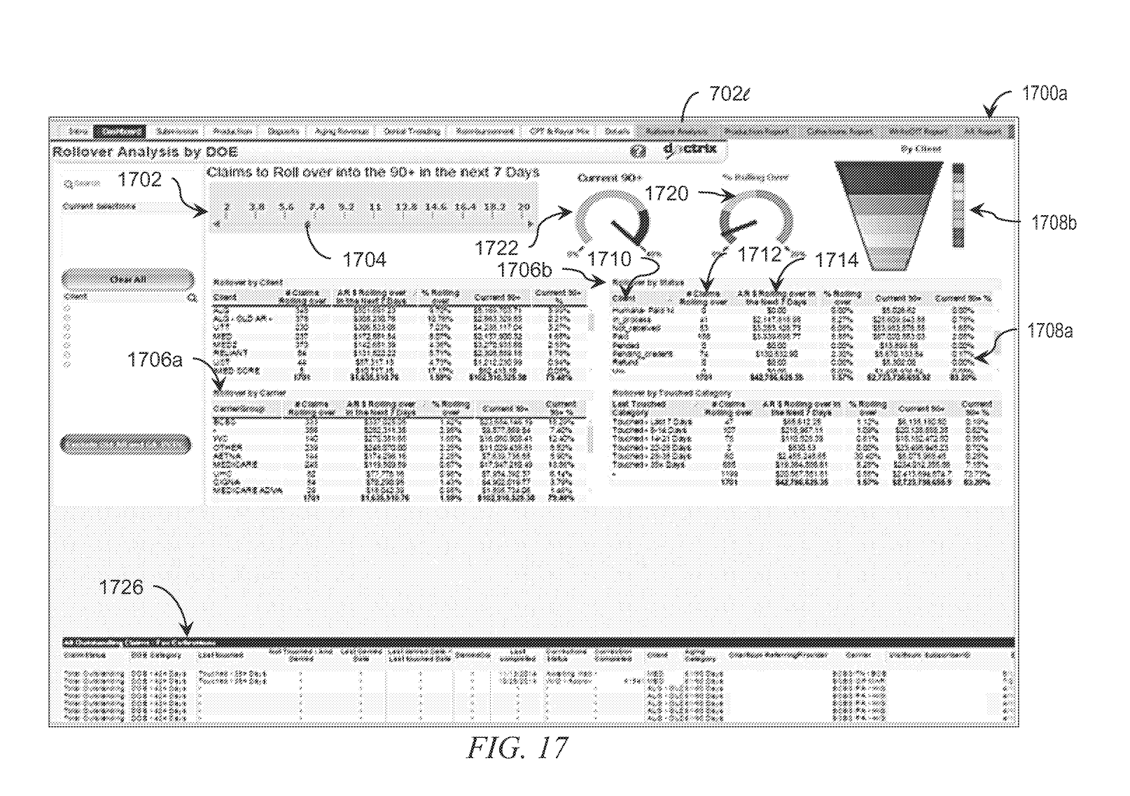

FIG. 17 is a screen shot of illustrative rollover analysis dashboards that enable a user to dynamically select a number of days after which uncollected claims will rollover into a 90+ day AR bucket and to view summary and/or claim-level data. With regard to FIG. 17A, a rollover analysis dashboard 1700a is shown. The dashboard 1700a may be shown in response to a user selecting a “rollover analysis” tab 702l. The dashboard 1700a may include a graphical scale 1702 by which the user may use a selectable element 1704 to slide along the graphical scale 1702 to select a preferred number of days scale to identify the uncollected claims that will into a 90+ day AR bucket. The selection element 1704 may be slid to select different numbers of days prior to uncollected claims rollover into the 90 day AR bucket. As understood in the art, a 90 day AR bucket tends to represent a date after which collections drop significantly. Hence, by providing a selectable and dynamic graphical scale 1702, the user may be able to better manage collections prior to uncollected claims extending past 90 days.

Two analysis points 1706a and 1706b (collectively 1706) may enable a user to view uncollected claims by carrier and by status, respectively. In response to the user viewing the “By Carrier” tab 1706a, a chart 1708a may be displayed that includes name of carrier 710, number of claims 712, and claim amounts that will be rolled over into the 90 day AR bucket in the next number (e.g., six) days 1714. A claim-level table 1726 showing each of the claims that are going to be rolling over in the next number of days may also be shown. The table 1726 may include data, such as carrier, claim ID, date of service, amount billed, amount paid, amount written off, and outstanding balance. Additional and/or alternative data may be included in the table 1708a, summary section 1716, and table 1726. The dashboard 1700b includes chart 1708b in response to a user selecting the “By Status” tab 1706b.

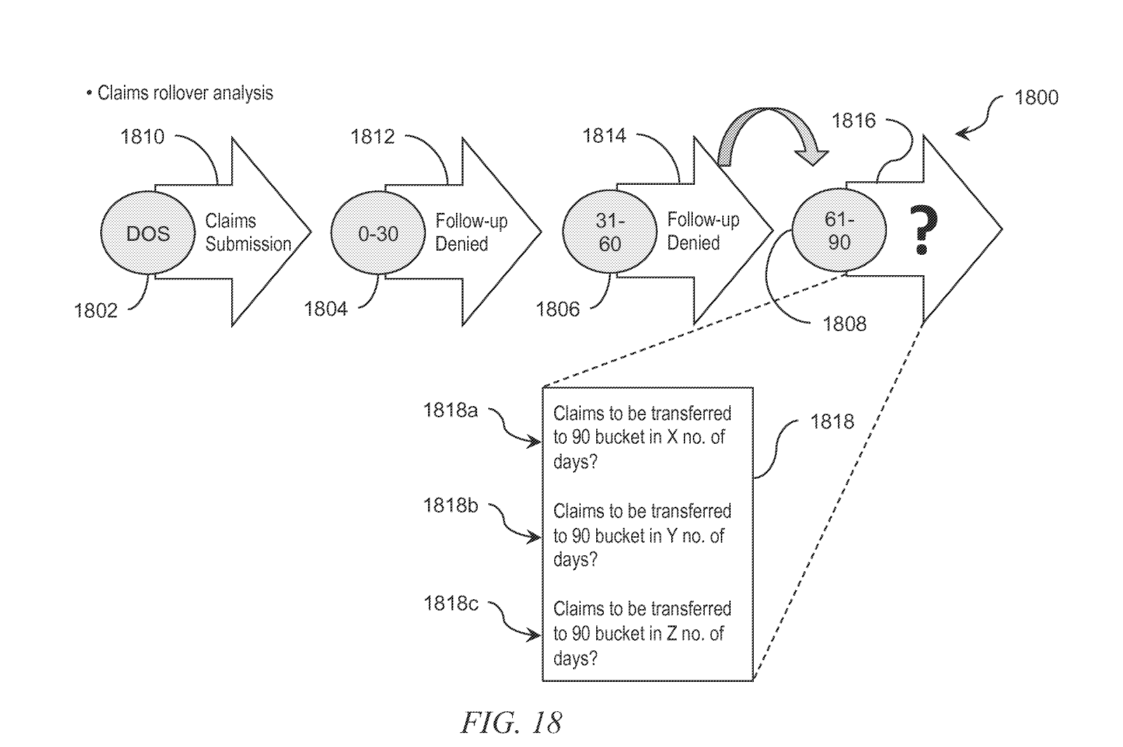

FIG. 18 is an illustration of an illustrative claims rollover analysis process. With regard to FIG. 18, a claims rollover analysis process 1800 is shown. The process 1800 may include a number of time periods, including a date of service 1802 when a patient visits a medical service professional, 0-30 day AR bucket 1804 after the date of service 1802, 31-60 day AR bucket 1806 after the date of service 1802, and 61-90 day AR bucket 1808 after the date of service 1802. A claims submission process 1810 may be performed after the date of service and before the 0-30 day AR bucket 1804 begins. An AR follow-up process or denial of claims process 1812 may be performed during the 0-30 day AR bucket 1804. An AR follow-up or denial process 1814 may be performed during the 31-60 day AR bucket 1806. During the 61-90 day AR bucket 1808, a claims rollover analysis 1818 may be performed.

The claims rollover analysis process 1818 may include performing a number of sub-processes, including an analysis of claims to be transferred to a 90+ day AR bucket in X number of days 1818a, claims to be transferred to the 90+ day AR bucket in Y number of days, and claims to be transferred to the 90+ day AR bucket in Z number of days 1818c. It should be understood that the process 1818 may have more or fewer subset processes than those shown. It should also be understood that the analysis 1818 may be performed in other AR buckets, including after the 90+ day AR bucket.

The dashboard and other tabs interact with one another. The dashboard provides a snapshot view of the overall practice performance. The dashboard would display key performance indicators such as current and last month charges, deposits, visits, 90+ AR %, charge per claim, and payment per claim. The details of the charges could be investigated in the production tab, and further reviewed using the production by physician, production by CPT and similar tabs. Similarly the deposits tab could be drilled down in a manner of three to four clicks by visiting the deposits tab, the deposits by CPT, and deposits by physician. Any of the current selection criteria made would then reflect across the dashboard tabs including the details tab that would list the claims relating to the current selection. Hence there is a one to one interaction between the dashboards, the tabs, the sub tabs and the details tab at all interchanges levels.

Although the description is primarily directed to medical practices, the principles of the present invention may be utilized in other service provider industries in which services are provided and payment is received at a later date. For example, the same or similar principles may be adapted for the legal industry in which legal services are provided for clients, bills are sent to those clients for services rendered, and payment is to be received within a certain time period, such as 30 days. One of skill in the art of financial health management would be able to apply the teachings herein without undue experimentation as applying the principles of the present invention merely needs to have underlying nomenclature of services and billing definitions applied for each different industry.

The principles of the present invention provide for a predefined workflow through the use of tabs 702 (FIGS. 7-17) that assists a medical service provider in managing a medical practice. The workflow starts at appointments and progresses through a claims submission process, deposits, denial management, collections, and patient billing. As shown in FIG. 17, additional and/or alternative tabs may be provided for a user, as well. Through extraction and data processing of raw data of healthcare or practice management systems and financial systems used by a medical service provider, the principles of the present invention may provide for dynamic and interactive dashboard user interfaces that allow for a user to answer nearly any question, such as revenue cycle management questions, about a medical practice within a short period of time. Rather than creating static reports, the dashboards presented herein provide for interactive reports from which a user can selectably generate alternative views (e.g., different time periods) and be able to “drill down” to see detailed data (e.g., claim-level detail data) to be able to answer and access whatever information is desired. As provided herein, the data presented in the dashboards is in many cases unavailable through existing practice management systems or dynamically available to users.

The previous description is of a preferred embodiment for implementing the invention, and the scope of the invention should not necessarily be limited by this description. The scope of the present invention is instead defined by the following claims.

1. A method of performing medical services analytics, said method comprising:
collecting through a computing system raw medical services data from at least one practice management system (PMS) data repository operated by a medical service provider, the raw medical services data defining a first set of medical services data received from said PMS data repository, said PMS data repository being one PMS data repository among a plurality of PMS data repositories available to the computing system for collection of said raw medical services data;
mapping on the computing system the first set of medical services data to generate a second set of medical services data, said second set of medical services data including at least a portion of the raw medical services data and a set of transaction data of medical insurance claims;
calculating on the computing system a plurality of new medical services data elements using at least one pre-established transformation formula configured to process the second set of medical services data, said at least one transformation formula capable of associating information unrelated to medical services with the raw medical services data using geographical information and profit and loss information;
integrating on the computer system the plurality of new medical services data elements into the second set of medical services data to generate an integrated medical services data set; and
driving a dashboard display of graphical information using the computer system, said dashboard display showing the integrated medical services data set and supporting the access of the transaction data for medical insurance claims.

2. The method according to claim 1, wherein collecting the raw medical services data includes collecting a lowest level of medical services data.

3. The method according to claim 1, wherein the lowest level of medical services data includes claim level medical services data.

4. The method according to claim 1, wherein the collected raw medical services data does not include protected health information (PHI).

5. A method of presenting a dashboard display of information related to medical services analytics, said method comprising:
accessing through a computing system a medical services data set inclusive of data related to medical services performed by a medical services provider;
generating with the computer system a dashboard display having a graph or table, the dashboard display further including a plurality of workflow selectable element, that includes information related to time period, provider, insurance carrier, and medical procedure code;
causing the computer system to generate said dashboard display showing one or more tables or graphs in response to a selection of one or more selectable elements, said selectable elements including comprehensive RCM analysis, reviewing appointments, submissions, production, deposits, aging revenue, reimbursements or CPT and payer mix;
causing said dashboard display to show information relating to a rollover analysis of collections data that includes a data set of predictive data projected to not be collected by a certain data based on historical information;
causing said dashboard display to show information relating to an evidence based claims analysis including aging and reimbursements monitoring and the ability to investigate short pays or non-pays;
causing said dashboard display to show information relating to an appointment management analysis with the ability to project future cash flows whilst monitoring and maximizing recurrent patient trending;
causing said dashboard display to show information relating to a claims related time delay analysis during claims submission; and,
causing said dashboard display to show information relating to a physicians work comparison.

6. The system from analytical analysis of medical services and information, comprising:
a computing system that collects raw medical services data from at least one data repository, the raw medical services data defining a first set of medical services data received from a practice management system operated by a medical service provider;
one or more PMS data repositories coupled to said computer system, said computing system storing raw medical services data that is collected;
a data mapping protocol supported by the computing system that maps the first set of medical services data to generate a second set of medical services data, said second set of medical services data including at least a portion of the raw medical services data and transaction data of medical insurance claims;
a calculation protocol supported on the computing system that calculates a plurality of new medical services data elements by using at least one pre-established transformation formula configured to process the second set of medical services data, said at least one transformation formula associating information unrelated to medical services with the raw medical services data using geographical information and profit and loss information;
an integration protocol supported by the computer system that integrates the plurality of new medical services data elements into the second set of medical services data to generate an integrated medical services data set; and,
an interactive dashboard display driven by said computer system, said display showing the integrated medical services data set and having the ability to support access of the transaction data for medical insurance claims.

7. The system according to claim 6, wherein collecting the raw medical services data includes collecting a lowest level of medical services data.

8. The system according to claim 6, wherein the lowest level of medical services data includes claim level medical services data.

9. The system according to claim 6, wherein the collected raw medical services data does not include protected health information (PHI).

10. A method of performing medical services analytics, said method comprising:
collecting, by a computing system, raw medical services data from at least one data repository, the raw medical services data defining a first set of medical services data received from a practice management system operated by a medical service provider;
mapping, by the computing system, the first set of medical services data to generate a second set of medical services data;
calculating, by the computing system, a plurality of new medical services data elements by using at least one pre-established transformation formulas configured to process the second set of medical services data;
integrating, by the computer system, the plurality of new medical services data elements into the second set of medical services data to generate an integrated medical services data set; and
driving, by the computer system, a dashboard with the integrated medical services data set for the medical services provider to view.

11. The method according to claim 10, wherein the second set of medical services data includes at least a portion of the raw medical services data.

12. The method according to claim 11, wherein the second set of medical services data includes transaction data of medical insurance claims.

13. The method according to claim 12, wherein driving the dashboard includes driving the dashboard such that a user is able to access the transaction data of medical insurance claims within a maximum of three user interactions.

14. The method according to claim 10, wherein collecting the raw medical services data from at least one data repository includes collecting the raw medical services data from a practice management system (PMS) data repository.

15. The method according to claim 14, wherein collecting the raw medical services data includes collecting the raw medical services data from one PMS data repository from among a plurality of PMS data repositories available to collect raw medical services data.

16. The method according to claim 10, wherein using at least one pre-established transformation formulas includes using transformation formulas capable of associating information unrelated to medical services with the raw medical services data.

17. The method according to claim 16, wherein using formulas capable of associating information unrelated to medical services with the raw medical services data includes using transformation formulas that include geographical information.

18. The method according to claim 16, wherein using formulas capable of associating information unrelated to medical services with the raw medical services data includes using transformation formulas that include profit and loss information.

19. The method according to claim 10, wherein collecting the raw medical services data includes collecting a lowest level of medical services data.

20. The method according to claim 10, wherein the lowest level of medical services data includes claim level medical services data.

21. The method according to claim 10, wherein the collected raw medical services data does not include protected health information (PHI).

22. A method of presenting a dashboard for medical services analytics, said method comprising:
accessing, by a computing system, a medical services data set inclusive of data related to medical services performed by a medical services provider;
generating, by the computer system, the dashboard inclusive of a table, the dashboard further including a plurality of workflow selectable elements, the workflow selectable elements including time period, provider, insurance carrier, and medical procedure code; and
in response to a selection of a selectable element, causing, by the computer system, the table to display different respective data subsets in the table associated with the selected element.

23. The method according to claim 22, further comprising the step of providing, comprehensive RCM analysis, reviewing appointments, submissions, production, deposits, aging revenue, reimbursements and CPT & payer mix.

24. The method according to claim 22, further comprising the step of providing a rollover analysis of collections data.

25. The method according to claim 23, wherein providing a rollover analysis includes calculating a dataset that includes predictive data that is projected to not be collected by a certain data based on historical information.

26. The method according to claim 22, wherein providing evidence based claims aging and reimbursements monitoring, inclusive the ability to investigate short pays or non-pays.

27. The method according to claim 22, wherein providing the appointment management for RCM with the ability to project future cash flows whilst monitoring and maximizing recurrent patient trending.

28. The method according to claim 22, wherein providing the ability to track and reduce claims out time delays during claims submission.

29. The method according to claim 22, wherein providing the ability to monitor and reward the efficiency and effectiveness of the physicians based on work RVU comparisons.
